(19) United States
(12) Patent Application Publication
(10) Pub. No.: US 2026/0075664 A1
(43) Pub. Date: Mar. 12, 2026

(54) METHOD AND APPARATUS FOR PERFORMING RELAY COMMUNICATION IN A WIRELESS COMMUNICATION SYSTEM

(71) Applicant: LG ELECTRONICS INC., Seoul (KR)

(72) Inventors: Seoyoung BACK, Seoul (KR); Youngdae LEE, Seoul (KR); Seungmin LEE, Seoul (KR)

(73) Assignee: LG ELECTRONICS INC., Seoul (KR)

(21) Appl. No.: 19/326,363

(22) Filed: Sep. 11, 2025

(30) Foreign Application Priority Data
Sep. 11, 2024 (KR) 10-2024-0124228

(51) Int. Cl. H04W 76/10; H04W 24/10; H04W 88/04

(52) U.S. Cl. CPC H04W 76/10; H04W 24/10; H04W 88/04

(57) ABSTRACT

According to various embodiments, an apparatus may establish a first connection with a base station for user equipment-to-network (U2N) relay, establish a second connection with a first relay user equipment (UE) for the U2N relay, receive, through the first connection, a first message including a measurement reporting configuration, and, based on that a first local ID assigned for identifying a remote UE in relation to the first connection is further included in the first message, transmit, through the second connection, a second message for configuring measurement reporting for the first relay UE based on the measurement reporting configuration.

### CROSS-REFERENCE TO RELATED APPLICATIONS

Pursuant to 35 U.S.C. § 119(a), this application claims the benefit of earlier filing date and right of priority to Korean Patent Application No. 10-2024-0124228, filed on Sep. 11, 2024, the contents of which are all hereby incorporated by reference herein in their entireties.

### TECHNICAL FIELD

The present disclosure relates to a method and apparatus for performing multi-hop-based relay communication in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### SUMMARY

The object of the present disclosure is to provide a method for performing multi-hop-based user equipment-to-network (U2N) relay communication more accurately and efficiently.

It will be appreciated by those of ordinary skill in the art to which the embodiment(s) pertain that the objects that could be achieved with the embodiment(s) are not limited to what has been particularly described hereinabove and the above and other objects will be more clearly understood from the following detailed description.

In an aspect of the present disclosure, provided herein is a method performed by a user equipment (UE). The method includes: establishing a first connection with a base station (BS) for U2N relay; establishing a second connection with a first relay UE for the U2N relay; receiving, through the first connection, a first message including a measurement reporting configuration associated with the UE; and based on that a first local identifier (ID) assigned for identifying a remote UE in relation to the first connection is further included in the first message, transmitting, through the second connection, a second message for configuring measurement reporting for the first relay UE based on the measurement reporting configuration.

Alternatively, the second message may further include a second local ID assigned for identifying the remote UE in relation to the second connection, and the second local ID may be associated with the first local ID.

Alternatively, the second message may include configuration information for configuring measurement reporting for a third connection between the first relay UE and a second relay UE for the U2N relay.

Alternatively, the second message may include configuration information for configuring measurement reporting for one of the second connection or a third connection between the first relay UE and a second relay UE for the U2N relay.

Alternatively, the second message may further include a 1-bit indicator indicating the one connection.

Alternatively, the method may further include receiving a measurement report including measurement values measured based on the second message. The measurement report may include a first measurement value for a third connection between the first relay UE and a second relay UE, a second measurement value for a fourth connection between the second relay UE and the remote UE, and a second local ID assigned for identifying the remote UE in relation to the second connection.

Alternatively, the measurement report may further include information on hop counts corresponding to each of the first measurement value and the second measurement value.

Alternatively, the first relay UE may be in a radio resource control (RRC) idle state or an RRC inactive state.

Alternatively, the UE may be a last relay UE directly connected to the BS.

In another aspect of the present disclosure, provided herein is at least one non-transitory computer-readable storage medium including instructions that, when executed by at least one processor, cause the at least one processor to perform operations. The operations include: establishing a first connection with a BS for U2N relay; establishing a second connection with a first relay UE for the U2N relay; receiving, through the first connection, a first message including a measurement reporting configuration; and based on that a first local ID assigned for identifying a remote UE in relation to the first connection is further included in the first message, transmitting, through the second connection, a second message for configuring measurement reporting for the first relay UE based on the measurement reporting configuration.

In another aspect of the present disclosure, provided herein is a UE including: a radio frequency (RF) transceiver; and a processor connected to the RF transceiver. The processor is configured to control the RF transceiver to: establish a first connection with a BS for U2N relay; establish a second connection with a first relay UE for the U2N relay; receive, through the first connection, a first message including a measurement reporting configuration; and based on that a first local ID assigned for identifying a remote UE in relation to the first connection is further included in the first message, transmit, through the second connection, a second message for configuring measurement reporting for the first relay UE based on the measurement reporting configuration.

Alternatively, the second message may further include a second local ID assigned for identifying the remote UE in relation to the second connection, and the second local ID may be associated with the first local ID.

In another aspect of the present disclosure, provided herein is a processing device configured to control a UE. The processing device includes: at least one processor; and at least one memory connected to the at least one processor and configured to store instructions that, when executed by the at least one processor, cause the UE to: establish a first connection with a base station (BS) for U2N relay; establish a second connection with a first relay UE for the U2N relay; receive, through the first connection, a first message including a measurement reporting configuration; and based on that a first local ID assigned for identifying a remote UE in relation to the first connection is further included in the first message, transmit, through the second connection, a second message for configuring measurement reporting for the first relay UE based on the measurement reporting configuration.

In another aspect of the present disclosure, provided herein is a method performed by a first relay UE. The method includes: establishing a second connection with a UE for U2N relay; establishing a third connection with a second relay UE for the U2N relay; receiving, through the second connection, a second message for configuring measurement reporting associated with the first relay UE; and based on inclusion of a second local ID assigned for identifying a remote UE in relation to the second connection, transmitting, through the third connection, a third message for configuring measurement reporting for the second relay UE based on the second message.

In a further aspect of the present disclosure, provided herein is a first relay UE including: an RF transceiver; and a processor connected to the RF transceiver. The processor is configured to control the RF transceiver to: establish a second connection with a UE for U2N relay; establish a third connection with a second relay UE for the U2N relay; receive, through the second connection, a second message for configuring measurement reporting associated with the first relay UE; and based on inclusion of a second local ID assigned for identifying a remote UE in relation to the second connection, transmit, through the third connection, a third message for configuring measurement reporting for the second relay UE based on the second message.

According to an embodiment, multi-hop-based U2N relay communication may be performed more accurately and efficiently in a wireless communication system. For example, by configuring a local ID for a remote UE for each hop or SL connection in multi-hop U2N relay, the configuration of measurement reporting for each hop or SL connection may be rapidly performed even when there is an intermediate relay UE in an RRC idle or RRC inactive state.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining by comparing V2X communication based on RAT before NR and V2X communication based on NR.

FIG. 2 illustrates the structure of an LTE system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a communication structure available in a sixth-generation (6G) system according to an embodiment of the present disclosure.

FIG. 7 illustrates an electromagnetic spectrum according to an embodiment of the present disclosure.

FIG. 8 illustrates a radio protocol architecture for SL communication.

FIG. 9 illustrates user equipments (UEs) performing V2X or SL communication.

FIG. 10 illustrates resource units for V2X or SL communication.

FIG. 11 shows an example of a BWP, based on an embodiment of the present disclosure.

FIG. 12 illustrates a procedure in which UEs perform V2X or SL communication according to a transmission mode.

FIG. 13 illustrates a diagram for explaining the control plane procedure of L2 U2N relay (UE-to-Network Relay).

FIGS. 14 and 15 are diagrams for explaining functions of a sidelink relay adaptation protocol (SRAP) sublayer over a PC5 interface and a Uu interface.

FIGS. 16 and 17 are diagrams for explaining a method for assigning a local identifier (ID) in relation to initial connection establishment between a remote UE and relay UEs performing U2N relay.

FIG. 18 is a diagram for explaining a method for assigning a local ID when an intermediate relay UE is connected to a plurality of remote UEs.

FIGS. 19 and 20 are diagrams for explaining a method for configuring measurements related to an SL connection in a multi-hop U2N relay operation.

FIG. 21 is a diagram for explaining a method by which a UE performs a multi-hop-based U2N relay operation.

FIG. 22 is a diagram for explaining a method by which a first relay UE receives a measurement reporting configuration.

FIG. 23 illustrates a communication system applied to the present disclosure.

FIG. 24 illustrates wireless devices applicable to the present disclosure.

FIG. 25 illustrates another example of a wireless device to which the present disclosure is applied.

FIG. 26 illustrates a vehicle or an autonomous driving vehicle applied to the present disclosure.

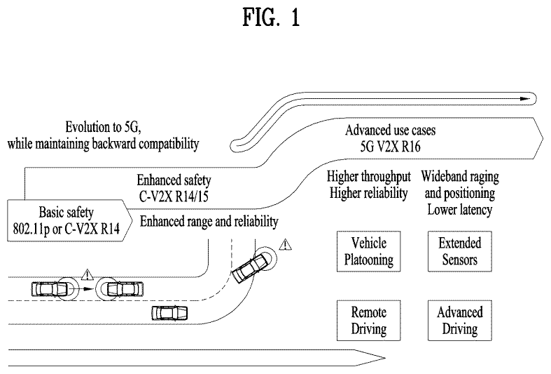

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto.

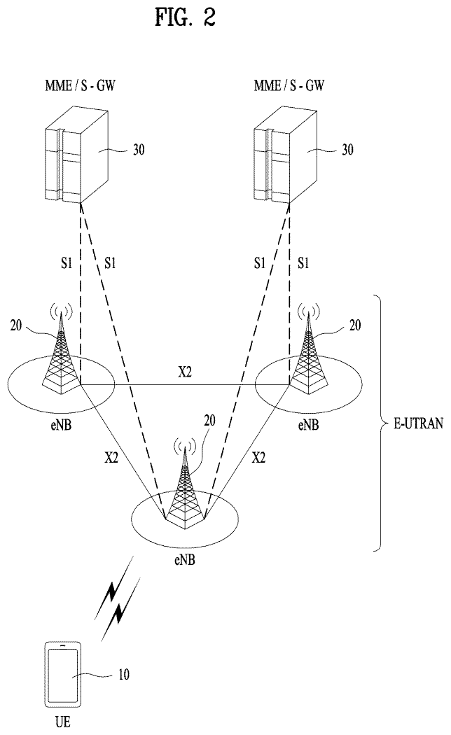

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an Si interface. More specifically, the eNB 20 is connected to a mobility management entity (MME) via an Si-MME interface and to a serving gateway (S-GW) via an Si-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2), and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

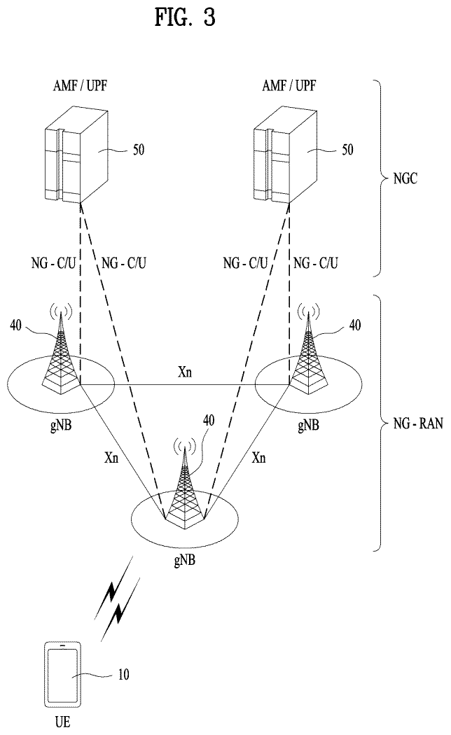

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

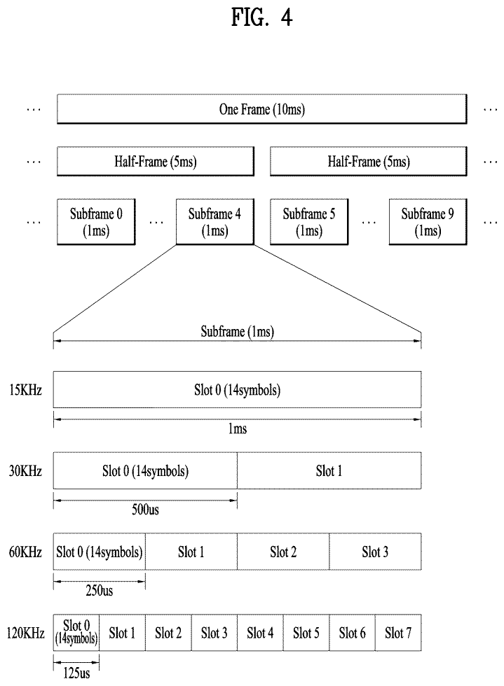

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration in the NCP case.

TABLE 1

| | | | |
|---|---|---|---|
| SCS (15*2u) | N^{slot}_{symb} | N^{frame, u}ₛₗₒₜ | N^{subframe, u}ₛₗₒₜ |

| | | | | |
|---|---|---|---|---|
| 15 kHz | (u = 0) | 14 | 10 | 1 |
| 30 kHz | (u = 1) | 14 | 20 | 2 |
| 60 kHz | (u = 2) | 14 | 40 | 4 |
| 120 kHz | (u = 3) | 14 | 80 | 8 |
| 240 kHz | (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM(A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier | |
|---|---|---|---|
| designation | frequency range | Spacing (SCS) | |
| FR1 | 450 MHz-6000 MHz | 15, 30, 60 | kHz |
| FR2 | 24250 MHz-52600 MHz | 60, 120, 240 | kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier | |
|---|---|---|---|
| designation | frequency range | Spacing (SCS) | |
| FR1 | 410 MHz-7125 MHz | 15, 30, 60 | kHz |
| FR2 | 24250 MHz-52600 MHz | 60, 120, 240 | kHz |

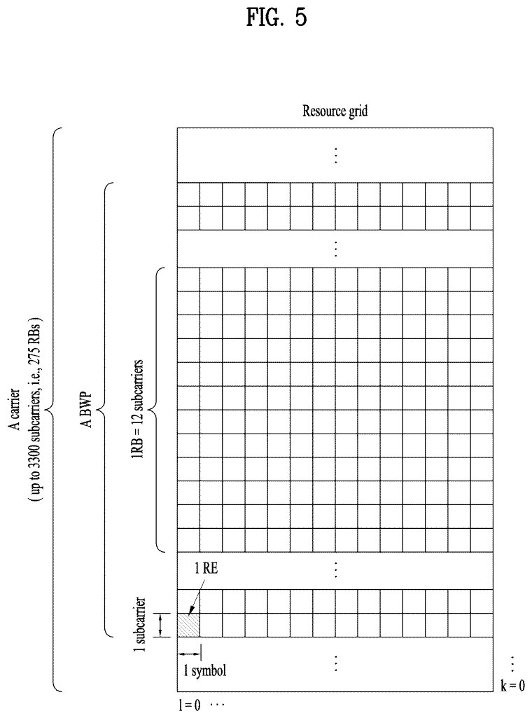

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

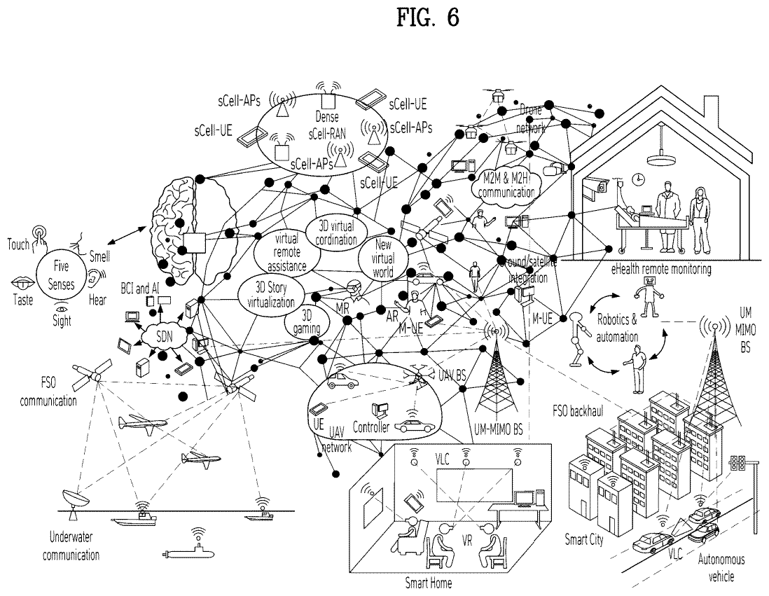

FIG. 6 illustrates a communication structure available in a sixth-generation (6G) system according to an embodiment of the present disclosure. The embodiment of FIG. 6 may be combined with various embodiments of the present disclosure.

In 6G, new network features may include the following.

### Integrated Satellite Network

Connected intelligence: In contrast to previous generations of wireless communication systems, 6G may update the wireless advancement from “connected things” to “connected intelligence”. Artificial intelligence (AI) may be applied in each step of communication procedures (i.e., each step of signal processing to be described later).
Seamless integration of wireless information and energy transfer
Ubiquitous super three-dimensional (3D) connectivity: Access to networks and core network functions pm drones and very low earth orbit satellites may enable super 3D connectivity in 6G universal.

Regarding the new network feature of 6G as described above, several common requirements may include the following:
Small cell networks
Ultra-dense heterogeneous networks
High-capacity backhaul
Radar technology integrated with mobile technology: High-accuracy localization via communication (or location-based service) is one of the functionalities of the 6G wireless communication system. Therefore, radar systems will be integrated with the 6G network.

### Softwarization and Virtualization

Hereinafter, the key implementation technologies of the 6G system will be described.
Artificial intelligence (AI): Introducing AI into communication may simplify and enhance real-time data transmission. AI may determine how complex tasks are performed using numerous analyses. In other words, AI may increase efficiency and reduce processing delays. Time-consuming tasks such as handover, network selection, and resource scheduling may be performed instantly with the use of AI. AI may also play a crucial role in machine-to-machine (M2M), machine-to-human, and human-to-machine communication. In addition, AI may enable rapid communication in a brain-computer interface (BCI). AI-based communication systems may be supported by metamaterials, intelligent architectures, intelligent networks, intelligent devices, intelligent recognition radios, self-sustaining wireless networks, and machine learning.
Terahertz (THz) communication: Increasing the bandwidth may enhance data transmission rates, which may be achieved by using sub-THz communication with wide bandwidths and applying the advanced massive multiple input multiple output (MIMO) technology. THz waves, also known as submillimeter radiation, typically represent frequency bands between 0.1 THz and 10 THz, corresponding to wavelengths in the range of 0.03 mm to 3 mm. The band range from 100 GHz to 300 GHz (sub-THz band) is considered to be the main part of the THz band for cellular communications. Adding the sub-THz band to mmWave bands increases the capacity of 6G cellular communications. The band from 300 GHz to 3 THz of the defined THz band falls within the far infrared (IR) frequency band. The band from 300 GHz to 3 THz is part of the optical band, but the band lies at the boundary of the optical band and immediately after the RF band. Therefore, this 300 GHz to 3 THz band shows similarities to RF.

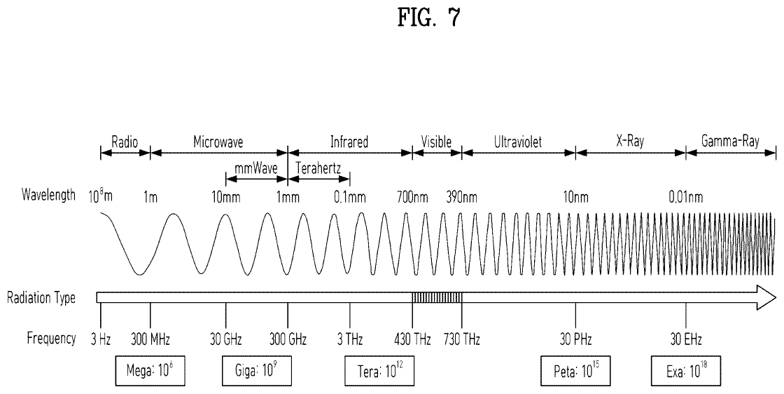

FIG. 7 illustrates an electromagnetic spectrum according to an embodiment of the present disclosure. The embodiment of FIG. 7 may be combined with various embodiments of the present disclosure. The key characteristics of THz communication include: (i) wide available bandwidths to support very high data transmission rates, and (ii) high path losses at high frequencies (highly directional antennas are indispensable). Narrow beamwidths generated by highly directional antennas reduce interference. The small wavelengths of THz signals allow a larger number of antenna elements to be incorporated into devices and BSs operating in this band. This enables the use of advanced adaptive array technologies capable of overcoming range limitations.
Large-scale MIMO technology
Hologram beamforming (HBF)
Optical wireless technology
Free-space optical (FSO) backhaul network
Quantum communication
Cell-free communication
Integration of wireless information and power transmission
Integration of wireless communication and sensing
Integrated access and backhaul network
Big data analysis
Reconfigurable intelligent surface
Metaverse
Blockchain
Unmanned aerial vehicle (UAV): UAVs or drones will be crucial elements in 6G wireless communication. In many cases, high-data-rate wireless connectivity may be provided using the UAV technology. BS entities may be installed on UAVs to provide cellular connectivity. The UAV may possess specific capabilities not found in fixed BS infrastructure, such as easy deployment, robust line-of-sight links, and degrees of freedom with controlled mobility. During emergencies such as natural disasters, the deployment of terrestrial communication infrastructure may not be economically feasible, and sometimes, it is impossible to provide services in volatile environments. The UAV may easily handle such situations. The UAV will represent a new paradigm in wireless communication. This technology facilitates the three fundamental requirements of wireless networks: enhanced mobile broadband (eMBB), ultra-reliable low latency communications (URLLC), and massive machine type communications (mMTC). In addition, the UAV may support various purposes such as improving network connectivity, fire detection, disaster emergency services, security and surveillance, pollution monitoring, parking monitoring, and accident monitoring. Therefore, the UAV technology is recognized as one of the most important technologies in 6G communication.
Autonomous driving (self-driving): Vehicle-to-everything (V2X) communication, a key element in establishing autonomous driving infrastructure, refers to a technology that allows vehicles to communicate and share information with various elements on the road, such as vehicle-to-vehicle (V2V) and vehicle-to-infrastructure (V2I) wireless communications. To maximize the performance of autonomous driving and ensure high safety standards, fast transmission speeds and low-latency technologies are essential. In addition, autonomous driving in the future may involve actively intervening in vehicle operation and directly controlling vehicles in hazardous situations beyond just providing warnings or guidance messages to drivers. To accommodate the vast amount of information that needs to be transmitted and received, it is expected in 6G that autonomous driving capabilities will be maximized with faster transmission speeds and lower latency compared to 5G.

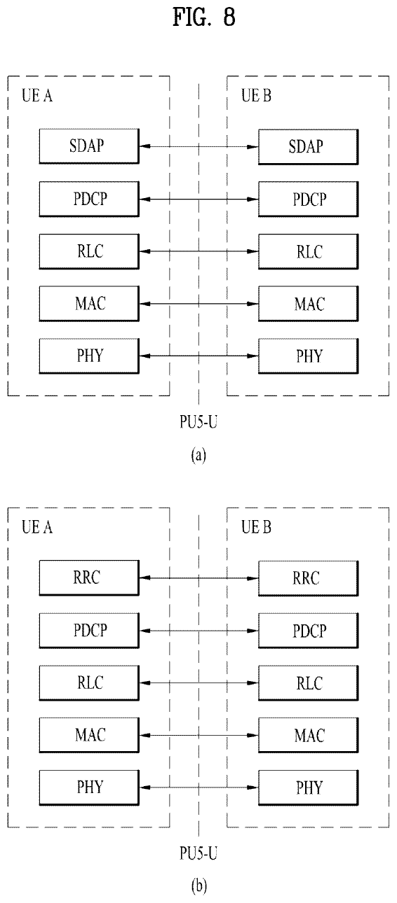

FIG. 8 illustrates a radio protocol architecture for SL communication. Specifically, FIG. 8-(a) shows a user plane protocol stack of NR, and FIG. 8-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre)set sidelink BWP (SL BWP). For example, the bandwidth of the S-SSB may be 11 resource blocks (RBs). For example, the PSBCH may span 11 RBs. The frequency position of the S-SSB may be (pre)set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

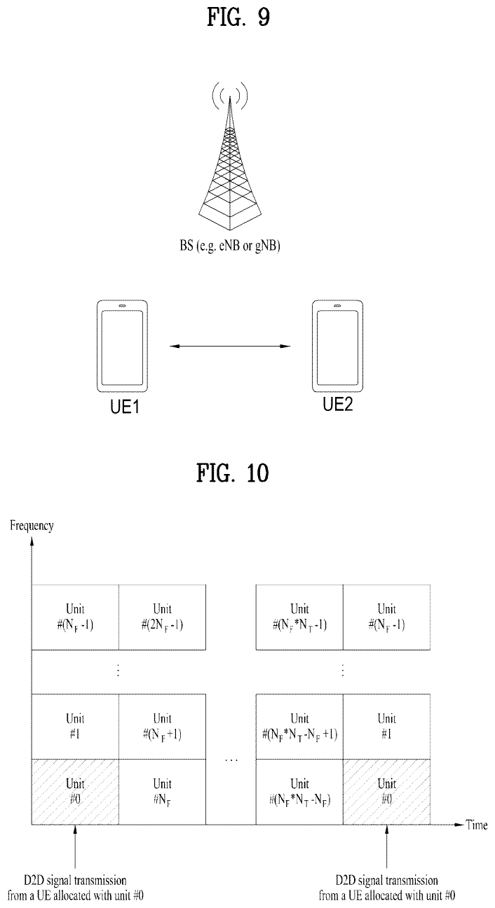

FIG. 9 illustrates UEs performing V2X or SL communication.

Referring to FIG. 9, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

FIG. 10 illustrates resource units for V2X or SL communication.

Referring to FIG. 10, the frequency resources of a resource pool may be divided into N_{F} sets, and the time resources of the resource pool may be divided into N_{T} sets. Accordingly, a total of N_{F}*N_{T} resource units may be defined in the resource pool. FIG. 10 shows an exemplary case where the resource pool is repeated with a periodicity of N_{T} subframes.

As shown in FIG. 10, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.

(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.

(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.

(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

FIG. 11 shows an example of a BWP, based on an embodiment of the present disclosure. The embodiment of FIG. 11 may be combined with various embodiments of the present disclosure. It is assumed in the embodiment of FIG. 11 that the number of BWPs is 3.

Referring to FIG. 11, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described. The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre)set sidelink BWP (SL BWP). For example, the bandwidth of the S-SSB may be 11 resource blocks (RBs). For example, the PSBCH may span 11 RBs. The frequency position of the S-SSB may be (pre)set. Accordingly, the UE does not need to perform hypothesis detection at a frequency to discover the S-SSB in the carrier.

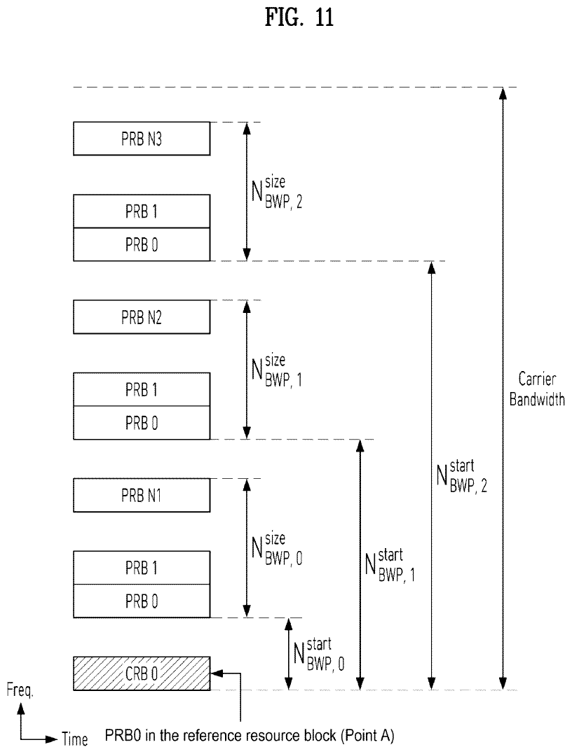

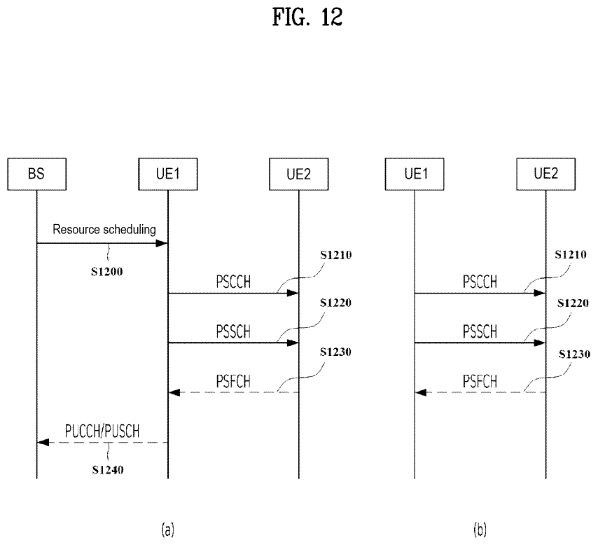

FIG. 12 illustrates a procedure for a terminal to perform V2X or SL communications in accordance with a resource allocation mode, according to one embodiment of the present disclosure. The embodiment of FIG. 12 may be combined with various embodiments of the present disclosure.

Referring to FIG. 12-(a), in LTE transmission mode 1, LTE transmission mode 3 or NR resource allocation mode 1, the BS may schedule an SL resource to be used by the UE for SL transmission. For example, in step S1200, the base station may transmit to the first terminal information associated with the SL resource and/or information associated with the UL resource. For example, the UL resource may include a PUCH resource and/or a PUSCH resource. For example, the UL resource may be a resource for reporting SL HARQ feedback to the base station.

For example, the first UE may receive information related to dynamic grant (DG) resource(s) and/or information related to configured grant (CG) resource(s) from the base station. For example, the CG resource(s) may include CG type 1 resource(s) or CG type 2 resource(s). In the present disclosure, the DG resource(s) may be resource(s) configured/allocated by the base station to the first UE through a downlink control information (DCI). In the present disclosure, the CG resource(s) may be (periodic) resource(s) configured/allocated by the base station to the first UE through a DCI and/or an RRC message. For example, in the case of the CG type 1 resource(s), the base station may transmit an RRC message including information related to CG resource(s) to the first UE. For example, in the case of the CG type 2 resource(s), the base station may transmit an RRC message including information related to CG resource(s) to the first UE, and the base station may transmit a DCI related to activation or release of the CG resource(s) to the first UE.

In step S1210, the first UE may transmit a PSCCH (e.g., sidelink control information (SCI) or 1st-stage SCI) to a second UE based on the resource scheduling. In step S1220, the first UE may transmit a PSSCH (e.g., 2nd-stage SCI, MAC PDU, data, etc.) related to the PSCCH to the second UE. In step S1230, the first UE may receive a PSFCH related to the PSCCH/PSSCH from the second UE. For example, HARQ feedback information (e.g., NACK information or ACK information) may be received from the second UE through the PSFCH. In step S1240, the first UE may transmit/report HARQ feedback information to the base station through the PUCCH or the PUSCH. For example, the HARQ feedback information reported to the base station may be information generated by the first UE based on the HARQ feedback information received from the second UE. For example, the HARQ feedback information reported to the base station may be information generated by the first UE based on a pre-configured rule. For example, the DCI may be a DCI for SL scheduling.

Referring to (b) of FIG. 12, in the LTE transmission mode 2, the LTE transmission mode 4, or the NR resource allocation mode 2, a UE may determine SL transmission resource(s) within SL resource(s) configured by a base station/network or pre-configured SL resource(s). For example, the configured SL resource(s) or the pre-configured SL resource(s) may be a resource pool. For example, the UE may autonomously select or schedule resource(s) for SL transmission. For example, the UE may perform SL communication by autonomously selecting resource(s) within the configured resource pool. For example, the UE may autonomously select resource(s) within a selection window by performing a sensing procedure and a resource (re)selection procedure. For example, the sensing may be performed in a unit of subchannel(s). For example, in step S1210, a first UE which has selected resource(s) from a resource pool by itself may transmit a PSCCH (e.g., sidelink control information (SCI) or 1st-stage SCI) to a second UE by using the resource(s). In step S1220, the first UE may transmit a PSSCH (e.g., 2nd-stage SCI, MAC PDU, data, etc.) related to the PSCCH to the second UE. In step S1230, the first UE may receive a PSFCH related to the PSCCH/PSSCH from the second UE.

Referring to (a) or (b) of FIG. 12, for example, the first UE may transmit a SCI to the second UE through the PSCCH. Alternatively, for example, the first UE may transmit two consecutive SCIs (e.g., 2-stage SCI) to the second UE through the PSCCH and/or the PSSCH. In this case, the second UE may decode two consecutive SCIs (e.g., 2-stage SCI) to receive the PSSCH from the first UE. In the present disclosure, a SCI transmitted through a PSCCH may be referred to as a 1st SCI, a first SCI, a 1st-stage SCI or a 1st-stage SCI format, and a SCI transmitted through a PSSCH may be referred to as a 2nd SCI, a second SCI, a 2nd-stage SCI, or a 2nd-stage SCI format.

Referring to (a) or (b) of FIG. 12, at step S1230, the first terminal may receive the PSFCH. For example, the first terminal and the second terminal may determine a PSFCH resource, and the second terminal may use the PSFCH resource to transmit HARQ feedback to the first terminal.

Referring to (a) of FIG. 12, at step S1240, the first terminal may transmit the SL HARQ feedback to the base station via PUCCH and/or PUSCH.

The sidelink described above may be defined as communication between UEs or direct communication between UEs. In this case, the PSCCH may be defined as a physical control channel for communication between UEs, the PSSCH may be defined as a physical data channel or physical shared channel for communication between UEs, and the PSFCH may be defined as a physical feedback transmission channel between UEs.

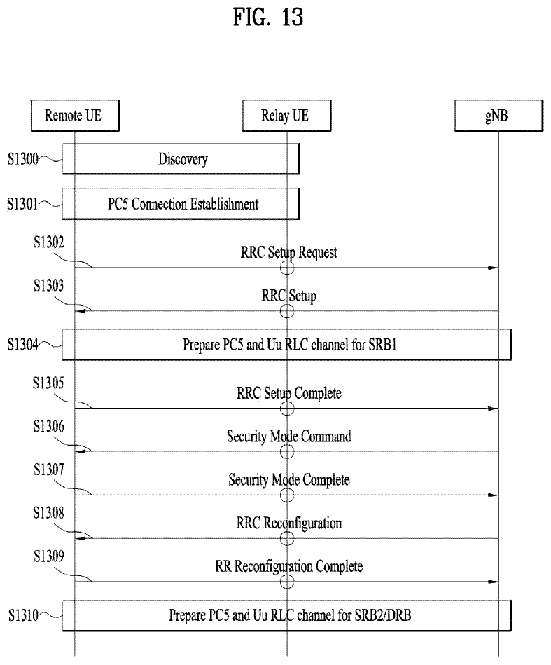

FIG. 13 illustrates a diagram for explaining the control plane procedure of L2 U2N relay (UE-to-Network Relay).

Regarding PC5-RRC in Rel-16 NR V2X, a PC5 unicast link establishment procedure may be reused to setup a secure unicast link between the remote UE and a relay UE for Layer 2 UE-to-network (L2 U2N) relaying before the remote UE establishes a Uu RRC connection with the network through the relay UE.

When a remote UE initiates the first RRC message for establishing a connection with a gNB, regardless of whether the remote UE is in-coverage or out-of-coverage, the PC5 L2 configuration for transmission between the remote UE and the U2N relay UE may be based on the standardized RLC/MAC configuration. The establishment of Uu SRB1/SRB2 and DRBs for the remote UE follows the legacy Uu configuration procedures applicable to L2 U2N relays.

Certain scenarios described in TS 38.300 specify control plane procedures for L2 U2N relays as follows.

In step S1300, the remote UE and relay UE may perform a discovery procedure. In step S1301, the remote UE and relay UE may establish a PC5-RRC connection based on legacy Rel-16 procedures.

In step S1302, the remote UE may transmit the first RRC message (i.e., RRCSetupRequest) to establish the connection with the gNB through the relay UE using the default PC5 L2 configuration. The gNB responds to the remote UE with an RRCSetup message (S1303). The default PC5 configuration is used to transmit the RRCSetup message to the remote UE. If the relay UE has not started in the RRC_CONNECTED state, the relay UE needs to establish the connection upon receiving a message about the default PC5 L2 configuration.

In step S1304, the gNB and relay UE perform a relay channel setup procedure over Uu. Depending on the configuration of the gNB, the relay/remote UE establishes an RLC channel for relaying SRB1 to the remote UE over PC5. This step prepares the relay channel for SRB1.

In step S1305, the SRB1 message (e.g., RRCSetupComplete message) from the remote UE is transmitted to the gNB through the relay UE on the SRB1 relaying channel over PC5. The remote UE establishes the RRC connection over Uu.

In step S1306 and S1307, the remote UE and gNB establish security according to legacy procedures, and a security message is transmitted through the relay UE.

In steps S1308 and S1309, the gNB transmits an RRCReconfiguration message to the remote UE through the relay UE to establish the SRB2/DRB for relaying. The remote UE responds to the gNB with an RRCReconfigurationComplete message through the relay UE.

In step S1310, the gNB establishes an additional RLC channel between the gNB and relay UE for traffic relay. Depending on the configuration of the gNB, the relay/remote UE establishes additional RLC channels between the remote UE and relay UE for traffic relay.

For L2 U2N relaying in addition to the connection establishment procedure:
The RRC reestablishment and RRC connection release procedures may reuse legacy RRC procedures along with the message content/configuration design left in the WI phase.
The RRC connection reestablishment and RRC connection resume procedures may reuse legacy RRC procedures as a baseline by considering the connection establishment procedure of the L2 U2N relay above to handle relay-specific parts along with message content/configuration design. The message content/configuration may be defined at a later stage.

### SRAP (Sidelink Relay Adaptation Protocol)

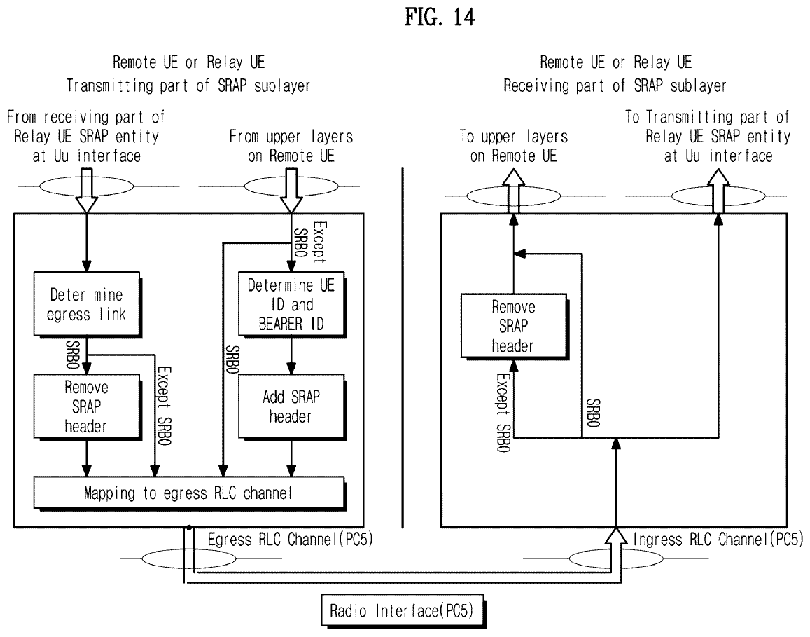

FIGS. 14 and 15 are diagrams schematically illustrating functions of an SRAP sublayer over a PC5 interface and a Uu interface.

The SRAP may be a protocol layer designed to support sidelink relay communication in a New Radio (NR) system. This protocol may be located above a radio link control (RLC) sublayer, which is positioned above a medium access control (MAC) layer and a physical (PHY) layer in a wireless interface protocol architecture. The SRAP is applicable to both a user plane (UP) and a control plane (CP) and may operate on both the PC5 interface (sidelink) and the Uu interface (cellular). Key functions of the SRAP include data transmission, determination of UE ID and bearer ID fields within a data packet, determination of an egress (transmission) link, and determination of an egress RLC channel.

The SRAP may play an important role particularly in an L2 UE-to-network (U2N) relay scenario. In this scenario, the SRAP sublayer of a relay UE may deliver data of a remote UE, received through the PC5 interface, to a gNB through the Uu interface, or vice versa. In this case, the SRAP may perform bearer mapping, and a data packet may include a UE ID identifying the remote UE and a bearer ID identifying the bearer. For example, in downlink transmission, the gNB may include, in a Uu SRAP header, end-to-end Uu radio bearer information of an L2 U2N remote UE and a local remote UE ID such that the relay UE is capable of identifying the end-to-end Uu radio bearer information and the local remote UE ID. The remote UE may associate a received packet with a correct PDCP entity based on identifier information included in a PC5 SRAP header. In the case of a specific bearer such as signaling radio bearer 0 (SRB0), data may be transmitted without an SRAP header, or the SRAP header may be added or removed by the relay UE.

FIG. 14 shows operations of an SRAP sublayer from the perspective of a relay UE or a remote UE.

In the case of a general data packet (excluding SRB0), a transmitting part may receive an SRAP data packet from a relay UE SRAP entity receiver of a Uu interface (in the case of a relay UE) or from an upper layer (in the case of a remote UE). An SRAP header may be added to the received data packet, and the header may include UE ID and bearer ID fields that are determined. These fields may be used to identify the destination of the data packet and the corresponding bearer. Subsequently, the data may be mapped to an appropriate egress PC5 relay RLC channel and transmitted to a lower layer. In the case of uplink transmission of an SRB0 data packet, an SRAP entity transmitter of a PC5 interface (L2 U2N remote UE) may receive an SRAP service data unit (SDU) from an upper layer but may configure and transmit a data protocol data unit (PDU) without an SRAP header.

A receiving part may receive an SRAP data PDU from a lower layer (PC5-RLC). In the case of a general data packet other than SRB0, the receiving part may remove an SRAP header and deliver an SRAP SDU to a relay UE SRAP entity transmitter of a Uu interface (in the case of a relay UE) or to an upper layer (in the case of a remote UE). In this case, the receiving part may use UE ID and bearer ID information included in the SRAP header to associate the received packet with a correct upper-layer entity. In the case of downlink reception of an SRB0 data packet, an SRAP entity receiver of a PC5 interface (L2 U2N relay UE) may receive an SRAP data PDU from an SRAP entity receiver of the Uu interface, remove an SRAP header, and deliver an SRAP SDU to an upper layer.

FIG. 15 shows operations of an SRAP sublayer from the perspective of a gNB side or a relay UE.

In the case of a general data packet (excluding SRB0), a transmitting part may receive an SRAP data packet from a relay UE SRAP entity receiver of a PC5 interface (in the case of a relay UE) or from an upper layer (in the case of a gNB). The transmitting part may configure an SRAP data PDU. In this case, an SRAP header may be included, and thus UE ID and bearer ID fields may be determined. For example, in the case of uplink relay traffic, the relay UE may include identification information of a remote UE and a bearer ID such that the gNB is capable of correctly processing the packet. The configured SRAP data PDU may be mapped to an appropriate egress Uu relay RLC channel and transmitted to a lower layer. In the case of an uplink SRB0 data packet, an SRAP SDU may be received from an SRAP entity receiver of a PC5 interface, and an SRAP header may be added to configure an SRAP data PDU. The UE ID field may correspond to sl-LocalIdentity, and the bearer ID field may be set to ‘0’.

A receiving part may receive an SRAP data PDU from a lower layer (Uu-RLC). In the case of a general data packet other than SRB0, the receiving part may deliver the SRAP data PDU as it is to an SRAP entity transmitter of a PC5 interface (in the case of a relay UE) or to an upper layer (in the case of a gNB). In the case of a downlink SRB0 data packet, an SRAP entity receiver of a Uu interface (L2 U2N relay UE) may receive an SRAP data PDU and then deliver the SRAP data PDU to an SRAP entity transmitter of a PC5 interface. The transmitter may then remove an SRAP header.

### (1) Transmission Operation of U2N Relay UE

A transmitting part of an SRAP entity located in a Uu interface of a U2N relay UE may receive an SRAP data packet from an SRAP entity receiver located in a PC5 interface of the same U2N relay UE and may configure an SRAP data PDU as necessary.

When the transmitting part of the SRAP entity located in the Uu interface has an SRAP data PDU to be transmitted, the transmitting part of the SRAP entity located in the Uu interface needs to perform the following:
When the SRAP data PDU is received from SL-RLC0 as defined in TS 38.331, the transmitting part determines a UE ID field and a bearer ID field. The transmitting part configures an SRAP data PDU including an SRAP header containing the UE ID field and the bearer ID field set to the determined values.

The transmitting part determines an egress RLC channel.

The transmitting part submits the SRAP data PDU to the determined egress RLC channel.

### (2) Determination of UE ID Field and Bearer ID Field

For an SRAP data PDU received from SL-RLC0, an SRAP entity needs to perform the following:
When sl-L2IdentityRemote that matches the L2 ID of a remote UE in the received SRAP data PDU is included in sl-RemoteUE-ToAddModList, the SRAP entity determines a UE ID field corresponding to sl-LocalIdentity configured for sl-L2IdentityRemote. The SRAP entity determines a bearer ID field as 0 (for example, set the bearer ID field to 0).

The SRAP may be configured through SL-SRAP-Config as shown in Table 5. SL-SRAP-Config may be configured for the UE through SL-L2RelayUE-Config included in an RRCReconfiguration message.

TABLE 5
ASN1START
-- TAG-SL-SRAP-CONFIG-START

| | |
|---|---|
| SL-SRAP-Config-r17 ::= | SEQUENCE { |
| sl-LocalIdentity-r17 | INTEGER (0..255) |

OPTIONAL, -- Need M

| | |
|---|---|
| sl-MappingToAddModList-r17 | SEQUENCE (SIZE (1..maxLC-ID)) |
| OF SL-MappingToAddMod-r17 | OPTIONAL, -- Need N |
| sl-MappingToReleaseList-r17 | SEQUENCE (SIZE (1..maxLC-ID)) OF |
| SL-RemoteUE-RB-Identity-r17 | OPTIONAL, -- Need N |

. . .
}

| | |
|---|---|
| SL-MappingToAddMod-r17 ::= | SEQUENCE { |
| sl-RemoteUE-RB-Identity-r17 | SL-RemoteUE-RB-Identity-r17, |
| sl-EgressRLC-ChannelUu-r17 | Uu-RelayRLC-ChannelID-r17 |

OPTIONAL, -- Cond L2RelayUE

| | |
|---|---|
| sl-EgressRLC-ChannelPC5-r17 | SL-RLC-ChannelID-r17 |

OPTIONAL, -- Need N
. . .
}

| | |
|---|---|
| SL-RemoteUE-RB-Identity-r17 ::= | CHOICE { |
| srb-Identity-r17 | INTEGER (0..3), |
| drb-Identity-r17 | DRB-Identity, |

. . .
}
-- TAG-SL-SRAP-CONFIG-STOP
-- ASN1STOP

Here, sl-LocalIdentity may indicate a local UE ID of an L2 U2N remote UE used in the SRAP, sl-MappingToAddModList may indicate a list of items to be added or modified among mappings between bearer IDs of L2 U2N remote UIEs and egress RLC channels, as defined in TS 38.351, sl-MappingToReleaseList may indicate a list of items to be released among mappings between bearer IDs of L2 U2N remote UiEs and egress RLC channels, as defined in TS 38.351, and sl-RemoteUiE-RB-Identity may indicate an end-to-end Uu bearer ID of an L2 U2N remote UiE (the value 3 of the srb-identity-r17 field (for configuring SRB3) may not be supported). In addition, sl-EgressRLC-ChannelUu may indicate an egress RLC channel on a Uu hop for uplink transmission at an L2 U2N relay UE, and sl-EgressRLC-ChannelPC5 may indicate an egress RLC channel on a PC5 hop for downlink transmission at an L2 U2N relay UE and for uplink transmission at an L2 U2N remote UE.

### Assignment of Local ID for Multi-Hop U2N Relay Operation

### 1. Control Procedure (Transmission of RRCSetupRequest/RRCSetup Message)

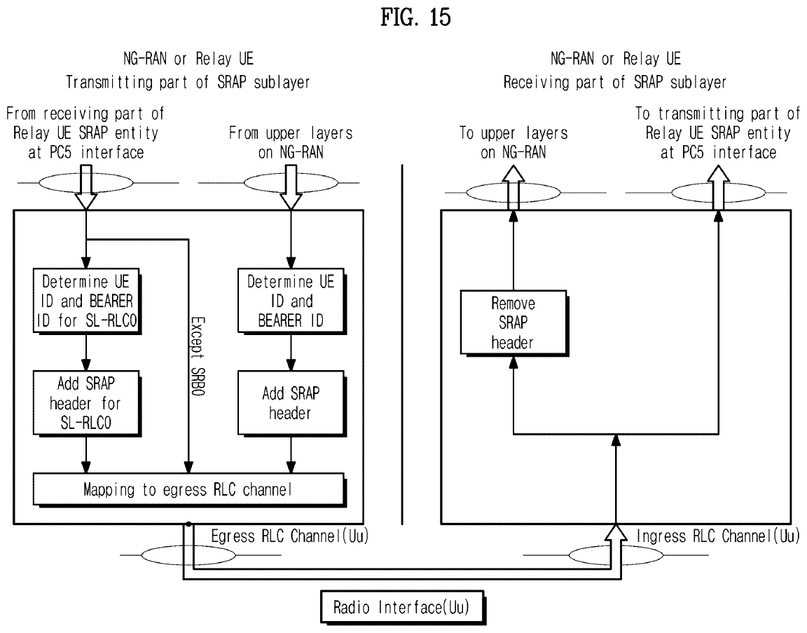

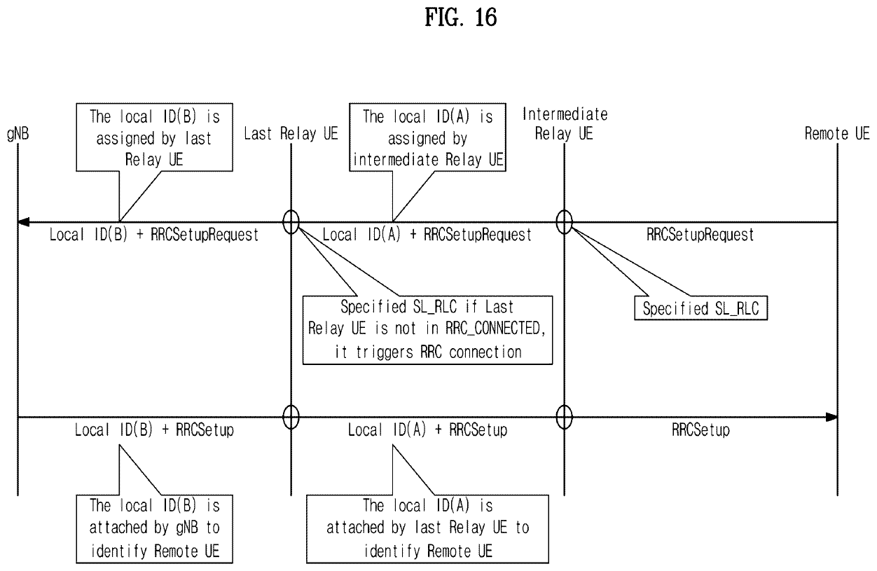

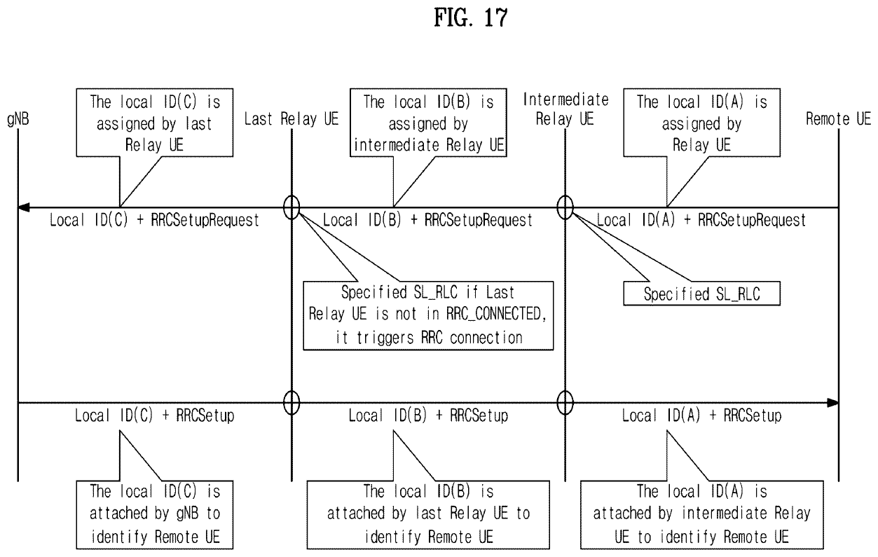

FIGS. 16 and 17 are diagrams for explaining a method for assigning a local ID in relation to initial connection establishment between a remote UE and relay UEs performing U2N relay.

The remote UE may transmit an RRC Setup Request message (e.g., RRCSetupRequest message) for establishing a connection with a gNB to a selected intermediate relay UE through a PC5-S connection (after a discovery process). This may be transmitted using specified SL-RLC, which may be the same as or different from specified SL-RLC (fixed logical channel) used for connection establishment between a source remote UE and a target remote UE in conventional U2U relay. When the intermediate relay UE receives the RRC Setup Request message from the remote UE through the specified SL-RLC (e.g., SL-RLC0) channel, the intermediate relay UE may transmit or forward the received RRC Setup Request message to a last relay UE through a specified SL-RLC channel. Upon receiving the RRC Setup Request message, if the last relay UE is in an RRC_IDLE or RRC_INACTIVE state, the last relay UE may initiate a procedure for connection establishment with the gNB.

Meanwhile, when a plurality of remote UEs simultaneously transmit a plurality of RRC Setup Request messages to the same intermediate relay UE, the intermediate relay UE needs to distinguish among the plurality of RRC Setup Request messages and transmit or forward the messages to the last relay UE. In this case, the following specific methods may be used.

### (1) Method 1

Referring to FIG. 16, when an intermediate relay UE receives an RRC Setup Request message (e.g., RRCSetupRequest message) from a remote UE, the intermediate relay UE may assign a local ID (e.g., a local ID for the remote UE). For example, when the intermediate relay UE receives the RRC Setup Request message from the remote UE, the intermediate relay UE may assign a local ID for the remote UE. The intermediate relay UE may attach an SRAP header including a local ID (A) and an SRB ID indicating SRB0 to the received RRC Setup Request message, and may transmit or forward the message to the last relay UE. When the intermediate relay UE receives RRC Setup Request messages from different remote UEs, the intermediate relay UE may assign different local IDs to the different remote UEs, and may store a mapping relationship between the local ID (A) assigned by the intermediate relay UE and an L2 ID pair (or one of a SRC L2 ID and a DST L2 ID) of the remote UE to which the local ID (A) is assigned.

When the last relay UE receives, from the intermediate relay UE, the RRC Setup Request message to which the (SRAP) header including the local ID (A) (assigned by the intermediate relay UE) is attached, the last relay UE may store a mapping relationship between the local ID (A) and an L2 ID pair of the intermediate relay UE. Alternatively, the last relay UE may store an association between the received local ID (A) and a local ID (B) assigned by the last relay UE. The last relay UE may attach to the RRC Setup Request message the local ID (B) directly assigned by the last relay UE, instead of the local ID (A) received from the intermediate relay UE and then transmit the message to the gNB. For example, the last relay UE may directly assign a new local ID (B) for the remote UE (or the intermediate relay UE), store an association between the local ID (A) and the local ID (B), and transmit or forward to the gNB the RRC Setup Request message received from the intermediate relay UE after attaching or including the local ID (B) instead of the local ID (A).

When the gNB receives the RRC Setup Request message (e.g., the RRC Setup Request message including the local ID (B)), the gNB may construct an RRC Setup message (e.g., RRCSetup message) for the remote UE, and may transmit the RRC Setup message including or attached with the (SRAP) header containing the local ID (B) to the last relay UE. Upon receiving the RRC Setup message, the last relay UE may attach or include, in the SRAP header, the local ID (A) associated with the local ID (B) instead of the local ID (B), and transmit the RRC Setup message to the intermediate relay UE. Upon receiving the message, the intermediate relay UE may detach the SRAP header, identify or determine the L2 ID associated with the local ID (A), and transmit only the RRC Setup message to the remote UE corresponding to the identified L2 ID. When the remote UE receives the RRC Setup message, the remote UE may determine that the connection (or RRC connection) with the gNB is completed.

Each of the last relay UE and the intermediate relay UE may configure or assign a local ID value that is the same as or different from the local ID value each of the last relay UE and the intermediate relay UE has received. For example, the last relay UE and the intermediate relay UE may assign different local IDs or the same local ID for the same remote UE.

### (2) Method 2

Referring to FIG. 17, a remote UE may transmit to an intermediate relay UE an RRC Setup Request message having a local ID (A) assigned by the remote UE as a (SRAP) header (or an RRC Setup Request message with a (SRAP) header including the local ID (A)). Upon receiving the message, the intermediate relay UE may replace the local ID (A) with a local ID (B), which is a value that the intermediate relay UE is capable of identifying. In this case, the intermediate relay UE needs to store that the local ID (A) and the local ID (B) are associated with each other. The intermediate relay UE may transmit to a last relay UE an RRC Setup Request message having, as an SRAP header, the local ID (B) configured by the intermediate relay UE (where the header may also include an ID indicating SRB0). Upon receiving the message, the last relay UE may configure or assign a new local ID (C) that replaces the local ID (B), and may store that the local ID (B) and the local ID (C) are associated with each other. The last relay UE may transmit to the gNB an RRC Setup Request message having, as a (SRAP) header, the local ID (C) configured by the last relay UE (or an RRC Setup Request message with an SRAP header including the local ID (C)). Here, the local IDs (A), (B), and (C) may be local IDs for the same remote UE.

When the gNB receives the RRC Setup Request message including the (SRAP) header that contains the local ID (C), the gNB may transmit, to the last relay UE, an RRC Setup message having, as an SRAP header, the local ID (C) for the remote UE (or an RRC Setup message with an SRAP header including the local ID (C)). The last relay UE may transmit, to the intermediate relay UE, an RRC Setup message having, as a (SRAP) header, the local ID (B) associated with the stored local ID (C) (or an RRC Setup message with an SRAP header including the local ID (B)). Upon receiving the message, the intermediate relay UE may transmit, to the remote UE, an RRC Setup message having, as a (SRAP) header, the local ID (A) associated with the stored local ID (B) (or an RRC Setup message with an SRAP header including the local ID (A)).

Each of the last relay UE and the intermediate relay UE may configure or assign a local ID value that is the same as or different from the local ID value each of the last relay UE and the intermediate relay UE has received. For example, the last relay UE and the intermediate relay UE may assign different local IDs or the same local ID for the same remote UE.

FIG. 18 is a diagram for explaining a method for assigning a local ID when an intermediate relay UE is connected to a plurality of remote UEs.

When a local ID is assigned according to Method 1 and Method 2 described above, the following problems may arise.

For example, referring to FIG. 18, an intermediate relay UE may be connected to a remote UE (A) and a remote UE (B). In Method 1, the intermediate relay UE may attach a local ID (A) assigned by the intermediate relay UE to a data packet received from the remote UE (A) or a message including the data packet and transmit the data packet or message to a last relay UE. Similarly, another intermediate relay UE (B) may be connected to the same remote UE (B), and the other intermediate relay UE (B) may use the same local ID (A) to transmit, to the last relay UE, a data packet of the remote UE connected thereto or a message including the data packet (for example, since the intermediate relay UE (A) and the intermediate relay UE (B) are different relay UEs, a local ID duplication problem may occur). In this case, the SRAP entity of the last relay UE may not be able to distinguish to which remote UE the local ID included in the SRAP header of the received data packet or message corresponds.

Similarly, in Method 2, the remote UE (A) may attach a local ID (A) assigned by the remote UE (A) to a data packet or message and transmit the data packet or message to the intermediate relay UE, and the remote UE (B) may also attach a local ID (A) assigned by the remote UE (B) to a data packet or message and transmit the data packet or message to the intermediate relay UE. In this case, the intermediate relay UE may not be able to distinguish between the data packet or message of the remote UE (A) and the data packet or message of the remote UE (B) through the local ID (for example, since the remote UE (A) and the remote UE (B) are different UEs, a local ID duplication problem may occur).

To prevent such duplication problems, a method in which the last relay UE assigns a local ID to the intermediate relay UE (or a method in which the intermediate relay UE assigns a local ID to the remote UE) may be used.

For example, when an intermediate relay UE establishes an SL connection or a direct connection with remote UEs, the intermediate relay UE may assign a local ID (A) to a remote UE (A) and a local ID (B) to a remote UE (B). The remote UE (A) may transmit, to the intermediate relay UE, a message including a data packet (and/or a message for initial connection establishment such as RRCsetuprequest, RRCReestablishmentrequest, or RRCResumerequest). The remote UEs (A) and (B) connected to the intermediate relay UE may respectively use the local IDs (A) and (B) assigned by the intermediate relay UE. For example, the remote UE (A) may use the local ID (A), and the remote UE (B) may use the local ID (B), to transmit to the intermediate relay UE a message including a data packet (and/or a message for initial connection establishment such as RRCsetuprequest, RRCReestablishmentrequest, or RRCResumerequest). In this case, there may be no duplication problem in the intermediate relay UE. However, as illustrated in FIG. 18, when a single link, SL connection, or direct connection is established between the intermediate relay UE and the last relay UE, it may be problematic how the last relay UE is capable of distinguishing between the remote UE (A) and the remote UE (B). To address this problem, at least one of the following methods may be applied.

### (3) Method 3

A last relay UE may assign a local ID to an intermediate relay UE. For example, the last relay UE may assign a different local ID to another intermediate relay UE (or a remote UE) connected thereto. When the intermediate relay UE forwards a message received from the remote UE, the intermediate relay UE may attach, to the header of the message received from the remote UE, the local ID configured or assigned by the last relay UE and transmit the message to the last relay UE. In this case, even when the message received from the remote UE (and/or the other intermediate relay UE) already includes the local ID (e.g., the local ID assigned for the corresponding remote UE) (for example, when the intermediate relay UE assigns the local ID to the remote UE), the intermediate relay UE may attach the local ID assigned by the last relay UE (and/or a local ID assigned by an intermediate relay UE of a previous SL connection or link) and transmit the message (instead of attaching the local ID of the intermediate relay UE to the local ID included in the message). In contrast, when the local ID included in the message is replaced with the local ID of the intermediate relay UE (for example, when the local ID of a data packet received from the remote UE is switched to the local ID received from the last relay UE), the last relay UE that receives the message from the intermediate relay UE may not be able to distinguish from which remote UE the message has been transmitted.

For example, when the intermediate relay UE establishes an SL connection with the last relay UE, the intermediate relay UE may receive a local ID to be used by the intermediate relay UE from the last relay UE. In addition, when a remote UE (A) and a remote UE (B) establishes an SL connection with the intermediate relay UE, the remote UE (A) and the remote UE (B) may be assigned different local IDs from the intermediate relay UE. The assignment of a local ID may also be performed based on a request. For example, the remote UE may request the intermediate relay UE to assign or configure the local ID.

For example, when the remote UE (A) transmits an (initial) RRC Setup Request message (RRCReestablishmentrequest or RRCResumerequest message) to the intermediate relay UE, the remote UE (A) may include, in the message, an SRAP header containing the local ID (A) assigned by the intermediate relay UE and transmit the message to the intermediate relay UE. Upon receiving the message, the intermediate relay UE may transmit to the last relay UE a message including an SRAP header containing a local ID (A′) assigned by the last relay UE. In this case, the local ID (A′) may replace the value of the local ID (A). If the local ID (A′) to be used by the intermediate relay UE is not assigned, the intermediate relay UE may request the last relay UE to assign a new local ID. The intermediate relay UE may store that the local ID (A) is associated with the local ID (A′).

When the last relay UE receives an RRC Setup Request message having the SRAP header including the local ID (A′) from the intermediate relay UE but does not have a local ID pre-assigned by a gNB, the last relay UE may request the gNB to assign a new local ID. The last relay UE may forward the RRC Setup Request message to the gNB, using the local ID (A″) assigned from the gNB as the SRAP header value of the RRCSetupRequest message received from the intermediate relay UE. The last relay UE may store that the local ID (A′) is associated with the local ID (A″).

When the gNB receives the RRC Setup Request message having the SRAP header including the local ID (A″) from the last relay UE, the gNB may transmit an RRCSetup message including the local ID (A″) to the last relay UE. When the gNB transmits the message having the SRAP header including the local ID (A″) to the last relay UE, the gNB may store that the local ID (A″) is associated with a certain remote UE (and/or a UE having a cell radio network temporary identifier (C-RNTI) value). Upon receiving the message, the last relay UE may configure an SRAP header in which the local ID (A″) is replaced with the local ID (A′) based on the association between the local ID (A″) and the local ID (A′), and may transmit a message (e.g., RRCSetup message) including the SRAP header to the intermediate relay UE. Upon receiving the message, the intermediate relay UE may configure an SRAP header in which the local ID (A′) is replaced with the local ID (A) based on the association between the local ID (A′) and the local ID (A), and may transmit a message (e.g., RRCSetup message) including the SRAP header to the remote UE.

The local IDs configured for each of the remote UE, intermediate relay UE, and last relay UE may continue to be applied even after the RRC connection is completed.

The remote UE (A) and the remote UE (B) may transmit RRC Setup Request messages simultaneously (or within a short time) to the intermediate relay UE. In this case, if the last relay UE assigns only one local ID to the intermediate relay UE, the intermediate relay UE may request the last relay UE to assign an additional local ID. For example, when the intermediate relay UE assigns the local ID (A) to the remote UE (A) and the local ID (B) to the remote UE (B), the intermediate relay UE may expect to receive an RRC Setup Request message having or including an SRAP header with the local ID (A) from the remote UE (A) and an RRC Setup Request message having or including an SRAP header with the local ID (B) from the remote UE (B). In this case, since only one local ID is assigned to the intermediate relay UE from the last relay UE after establishing an SL connection therebetween, the intermediate relay UE may request the last relay UE to additionally assign local IDs in order to forward the RRC Setup Request messages of different remote UEs. Alternatively, the intermediate relay UE may be configured to use a local ID assigned when establishing the SL connection with the last relay UE to transmit a message thereof and newly receive additional local IDs for forwarding the messages of the remote UEs. This may serve as an implicit method for the last relay UE to identify which intermediate relay UE is directly connected thereto. In this case, the intermediate relay UE may request two additional local IDs from the last relay UE and may use each of the two local IDs for forwarding the RRC Setup Request message received from the remote UE (A) and the RRC Setup Request message received from the remote UE (B), respectively.

Hereinafter, a method of configuring SL measurement reporting based on a local ID configured according to at least one of Methods 1 to 3 described above will be described in detail.

### Method for Configuring SL Measurement Reporting for Multi-Hop U2N Relay Operation

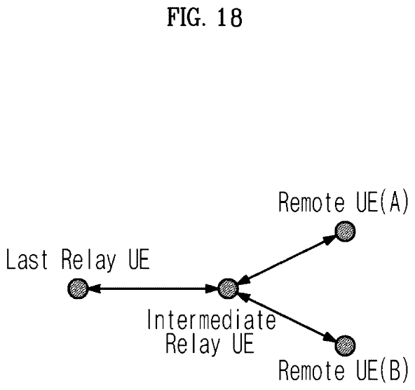

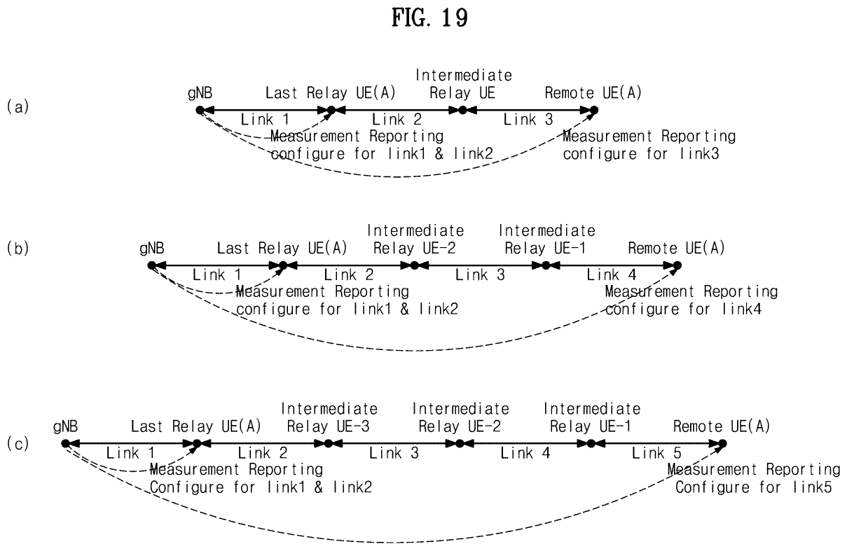

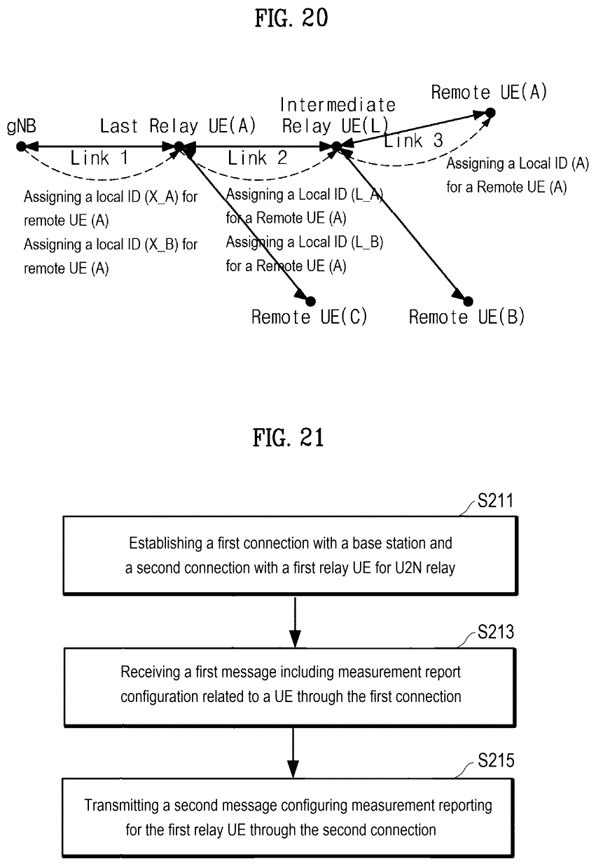

FIGS. 19 and 20 are diagrams for explaining a method for configuring measurements related to an SL connection in a multi-hop U2N relay operation.

Hereinafter, a method by which a gNB configures measurement reporting for each hop/SL connection and/or receives signal strength/measurement values for each hop when an intermediate relay UE is in an RRC_IDLE/RRC_INACTIVE state will be described in detail.

As described in Method 1 of “Assignment of local ID for multi-hop U2N relay operation,” a local ID used for a remote UE may be assigned by a gNB, a last relay UE, or an intermediate relay UE of a previous hop to a last relay UE, an intermediate relay UE, or a remote UE of a next hop, which is connected thereto, and may be used for transmission of a remote UE data PDU. A gNB, a last relay UE, or an intermediate relay UE may use the local ID for a remote UE associated therewith to perform data transmission and reception between the remote UE and the gNB. For example, as described in “Assignment of local ID for multi-hop U2N relay operation,” an intermediate relay UE connected to a remote UE may assign a local ID (A) for the remote UE (for example, a local ID for identifying the remote UE for an SL connection between the intermediate relay UE and a last relay UE) and may transmit the message/data of the remote UE to the last relay UE using the local ID (A). The last relay UE may assign a local ID (B) for the remote UE (for example, a local ID for identifying the remote UE for a Uu connection between the last relay UE and the gNB) and may transmit, to the gNB, the message/data of the remote UE received from the intermediate relay UE using the local ID (B). The gNB may transmit the message/data for the remote UE to the last relay UE using the local ID (B) assigned by the last relay UE, and the last relay UE may transmit the message/data for the remote UE to the intermediate relay UE using the local ID (A). Alternatively, as described in Method 2 of “Assignment of local ID for multi-hop U2N relay operation,” a gNB may assign a local ID for identifying a remote UE for a Uu connection with a last relay UE, and the last relay UE may assign another local ID for identifying the remote UE for an SL connection with an intermediate relay UE, such that local IDs are assigned for each hop or connection.

When the intermediate relay UE is in the RRC_IDLE/RRC_INACTIVE state, a method for measurement and measurement reporting for an SL connection or a direct connection may be as follows.

When the intermediate relay UE is in the RRC_IDLE/RRC_INACTIVE state, the gNB may not directly configure measurement reporting for an SL connection or a direct connection with the intermediate relay UE. Accordingly, the gNB may not directly receive, from the intermediate relay UE, the quality or measurement values of the SL connection or direct connection (through an indirect path).

For example, referring to FIG. 19(a), a gNB and a remote UE (A) may be connected through a last relay UE (A) and an intermediate relay UE (e.g., 2-hop U2N connection). In this case, the gNB may obtain the link quality of all of link 1, link 2, and link 3. For example, the gNB may configure the last relay UE (A) to perform measurement for signal strength on a Uu connection (i.e., link 1) and an SL connection (i.e., link 2), and may configure the remote UE (A) to perform measurement on an SL connection (i.e., link 3). According to this method, upon receiving measurement reports from the last relay UE (A) and the remote UE (A), the gNB may obtain the signal strength or quality for all of link 1, link 2, and link 3 that connect to the remote UE. Based on the signal strength or quality, the gNB may perform QoS (Quality of Service) splitting for each link or each hop.

However, as shown in FIGS. 19(b) and 19(c), when the number of intermediate relay UEs is two or more (for example, when the number of hops increases), the gNB may not obtain signal strength or quality for all SL connections associated with the intermediate relay UEs that are in the RRC_IDLE/RRC_INACTIVE state. For example, when the gNB configures only the last relay UE (A) and the remote UE (A) to perform measurement on SL connections or direct connections (while intermediate relay UE(s) are in the RRC_IDLE/RRC_INACTIVE state), the gNB may not receive reports on the signal strength or quality of the SL connections of the intermediate relay UE(s) (e.g., link 3 in the case of FIG. 19(b), and links 3 and 4 in the case of FIG. 19(c)). For example, unlike the case of FIG. 19(a), in the cases of FIGS. 19(b) and 19(c), since only the last relay UE (A) and the remote UE (A) are allowed to perform measurement, the gNB may not obtain signal strength or quality (or measurement information) for all SL connections.

Accordingly, when the gNB performs QoS splitting for each link or hop, a method for reporting the signal strength of a Uu link and multi-hop SL connections to the gNB may be required (even if there is an intermediate relay UE in the RRC_IDLE/RRC_INACTIVE state).

When the remote UE performs RRC connection establishment with the gNB, the remote UE may report QoS-related information to the gNB (via SUI or UAI). In this case, the remote UE may receive total hop count information up to the gNB from an upper layer (or may use a value known by an access stratum (AS) layer if the AS layer knows the value). The remote UE may report the total hop count information to the gNB together with QoS information. The gNB may establish an end-to-end (e2e) bearer with the remote UE using the QoS information received from the remote UE. Such a procedure may be performed regardless of the RRC state of the intermediate relay UE.

The gNB may also perform QoS splitting using an SL connection threshold used for selecting relay UEs for the multi-hop relay operation and/or a Uu link threshold (upper/lower bound; maximum/minimum threshold) required to serve as the last relay UE. For example, the gNB may assume that the SL connection or Uu link is established or connected with a quality equal to or higher than at least the threshold. Based on this assumption, the gNB may split the QoS (packet delay budget (PDB)) value (e.g., e2e QoS/PDB value). In this case (for example, when the gNB does not receive accurate signal strength reports for each hop or SL connection), the split QoS/PDB value may be configured to be the same among the SL hops.

When the gNB performs QoS splitting (for each hop or SL connection), the gNB may transmit the split QoS value(s) only to the last relay UE. The reason for this is that the last relay UE always maintains the RRC_CONNECTED state with the gNB on behalf of the remote UE when the remote UE is in the RRC_CONNECTED state. In this case, the last relay UE may determine the (split) QoS value for each hop or SL connection from the last relay UE to the remote UE using the split QoS value(s) configured by the gNB.

In relation to the method of configuring measurement reporting, the gNB may provide or notify the last relay UE of the following information when configuring measurement reporting, so as to configure measurement reporting for SL connections corresponding to a path leading to the remote UE.

Referring to FIG. 19(b) or FIG. 19(c), to indicate that measurement reporting is configured for an SL connection with a specific remote UE among multiple SL connections connected to the last relay UE (A) (for example, SL connections directly connected with a plurality of intermediate relay UEs, such as links 2, 3, 4, and 5), the gNB may transfer or transmit to the last relay UE (A) a message for configuring measurement reporting that further includes a local ID representing the stored remote UE (A). In this case, a local ID used by the last relay UE (A) for transmitting data of the remote UE (A) through the Uu link (e.g., a local ID assigned by the gNB or an ID assigned by the last relay UE) may be used when the measurement reporting is configured. The last relay UE (A) may configure measurement reporting for an SL connection to the intermediate relay UE associated with (or that may be associated with) the local ID included in the message. In this case, the configuration of measurement reporting configured by the last relay UE (A) should include the local ID assigned for transmission of data or messages of the remote UE in the SL connection or direct connection between the intermediate relay UE (e.g., a second intermediate relay UE in the case of FIG. 19(b) or a second intermediate relay UE in the case of FIG. 19(c)) and the last relay UE (A) (for example, the local ID may be a local ID assigned by the last relay UE or a local ID assigned by the intermediate relay UE). Similarly, the intermediate relay UE may configure measurement reporting for other intermediate relay UEs and/or the remote UE (based on the measurement reporting configuration received from or configured by the last relay UE for the SL connection). For example, when the message for configuring measurement reporting received from the last relay UE (A) includes a local ID, the intermediate relay UE may configure measurement reporting for other intermediate relay UEs and/or the remote UE (based on the measurement reporting configuration received from or configured by the last relay UE for the SL connection).

Specifically, referring to FIG. 20, a remote UE (A) may request an intermediate relay UE (L) to assign a local ID for transmitting a message (e.g., RRCSetupRequest, RRCReestablishment, or RRCResume) for initial connection establishment. The intermediate relay UE (L) may assign a local ID (A) for the remote UE (A) in response to the request for the local ID. The remote UE (A) may transmit to the intermediate relay UE (L) a message for initial connection establishment including an SRAP header that contains the local ID (A) assigned by the intermediate relay UE (L). When the intermediate relay UE (L) receives the message for initial connection establishment, the intermediate relay UE (L) may request a last relay UE (X) to assign a new local ID. In this case, the last relay UE (X) may assign a new local ID (L_A) to the intermediate relay UE (L). The intermediate relay UE (L) may transmit, to the last relay UE (X), the message for initial connection establishment (e.g., initial RRC message) received from the remote UE (A) by using the local ID (L_A) assigned by the last relay UE (X). Similarly, the last relay UE (X) may request the gNB to assign a local ID for the remote UE (A) in order to transmit to the gNB the message for initial connection establishment (e.g., initial RRC message) of the remote UE (A) received through the intermediate relay UE (L), and may receive a new local ID (X_A) from the gNB. The gNB and the last relay UE (X) may not identify which remote UE the local ID (X_A) corresponds to. The last relay UE (X) may only store mapping information indicating which local ID (local ID (X_A) used for transmitting a message or data to the gNB) is associated with the local ID (L_A) when the last relay UE (X) receives a message from the intermediate relay UE using the local ID (L_A). When the gNB receives an initial RRC message (i.e., an initial RRC message of the remote UE (A)) including or using the local ID (X_A) from the last relay UE (X), the gNB may include the local ID (X_A) in an RRC Setup message that configures a C-RNTI value to be used by the remote UE (A), based on the information related to the remote UE (A) included in the initial RRC message, and may transmit the RRCSetup message to the last relay UE. In this case, the gNB may not consider which intermediate relay UE is involved. After the configuration based on the initial RRC message, data PDUs between the remote UE (A) and the gNB may be transmitted and received using the local IDs for the remote UE (A) assigned or configured for each SL connection and Uu connection.

Next, when configuring measurement reporting, a local ID may be included to indicate which path is to be measured for signal strength. Referring to FIG. 20, when the gNB configures measurement reporting for the last relay UE (X), the gNB may include, in a message containing the configuration of the measurement reporting, the local ID (X_A) assigned for identifying the remote UE (A) in relation to link 1, in order to notify that the measurement reporting configuration corresponds to a path leading to the remote UE (A) (e.g., links 2 and 3). Upon receiving the message including the configuration of the measurement reporting, the last relay UE (X) may identify a local ID (e.g., local ID (L_A)) associated with the local ID (X_A) (which is assigned by the last relay UE (X)), as well as a (DST) L2 ID associated therewith. For example, when configuring SL measurement reporting for the last relay UE (X), the gNB may transmit or provide to the last relay UE (X) both the value recognized as the local ID (local ID (X_A)) that allows to reach the remote UE from the gNB, and information indicating that the SL measurement reporting configuration is to be propagated from the last relay UE (X) to a first intermediate relay UE (for example, the relay UE (L) connected to the remote UE through an SL connection).

Upon receiving the SL measurement reporting configuration including the local ID and indication information, the last relay UE (X) may configure for the intermediate relay UE (L) similar measurement reporting (which is the same as the value configured by the gNB for measurement of the SL connection), and the intermediate relay UE (L) may also configure similar measurement reporting for the remote UE (A).

When the gNB configures measurement reporting for the last relay UE (X) to measure an SL signal, the configuration of the measurement reporting may include the local ID (X_A) that the gNB recognizes as representing the remote UE (A). Additionally/alternatively, the configuration of the measurement reporting may further include an indicator or indication information indicating that the measurement reporting configuration is to be propagated to the remote UE (A) through multiple hops. The content of the measurement reporting configured by the last relay UE (X) for the intermediate relay UE may correspond to either case A or case B described below.

(1) Case A: The last relay UE (X) may provide or transmit to the intermediate relay UE (L) a measurement reporting configuration for measuring and reporting the signal strength (e.g., link 2) between the last relay UE (X) and the intermediate relay UE (L).

(2) Case B: The last relay UE (X) may provide or transmit to the intermediate relay UE (L) a measurement reporting configuration for measuring and reporting the signal strength (e.g., link 3) between the intermediate relay UE (L) and the remote UE (A).

In both case A and case B, the measurement reporting configuration may include the local ID assigned by the last relay UE to the intermediate relay UE for data transmission of the remote UE. Alternatively, the measurement reporting configuration may include a 1-bit indicator indicating whether the measurement reporting is for a previous link (e.g., link 2) or for a next link (e.g., link 3) with respect to the intermediate relay UE (L).

As described above, when the gNB configures measurement reporting for the last relay UE, and the measurement reporting is configured hop by hop from the last relay UE to the remote UE, a measurement value for an SL connection may be reported according to an event-based or periodic configuration. When such a measurement value is reported, the local ID included in the measurement reporting configuration may also be included in the report of the measurement value. In addition, upon receiving the report of the measurement value from the remote UE or the intermediate relay UE, the intermediate relay UE or the last relay UE may piggyback a measurement value measured by the intermediate relay UE or the last relay UE onto the received measurement report and transmit the two measurement values together. In this case, in the same manner, the local ID included by the intermediate relay UE or the last relay UE in the measurement reporting configuration may also be included in the report of the measurement values.

The remote UE or the intermediate relay UE may perform measurement reporting including the hop count value thereof. The reason for this is that upon receiving the measurement report, the last relay UE or the gNB needs to identify to which hop the measurement value included in the report corresponds. In particular, when the intermediate relay UE is in the RRC_IDLE/RRC_INACTIVE state, the gNB may not obtain information on the intermediate relay UE. Accordingly, the intermediate relay UE needs to clearly indicate to the gNB, through the hop count value, which hop the measurement value corresponds to. To this end, the intermediate relay UE or the remote UE may report the hop count value corresponding to the measurement value together.

For example, the remote UE (A) may report to the intermediate relay UE (L) a measurement report including the local ID (A) contained in the measurement reporting configuration, a hop count (and/or a total hop count, if applicable), and a measurement value (e.g., sidelink reference signal received power (SL-RSRP) or sidelink discovery reference signal received power (SD-RSRP) of link 3). The intermediate relay UE (L) may also report to the last relay UE (X) a measurement report including a local ID (L_A) contained in the measurement reporting configuration, a hop count, and a measurement value for link 2. Additionally/alternatively, the last relay UE may report to the gNB a measurement report including a local ID (X_A) contained in the measurement reporting configuration, a hop count, and a measurement value for link 1.

Alternatively, upon receiving a measurement report (e.g., first measurement report) from the remote UE (A), the intermediate relay UE (L) may forward the first measurement report of the remote UE (A) to the last relay UE (X). In this case, the intermediate relay UE (L) may also report to the last relay UE (X) the measurement value for link 2 measured by the intermediate relay UE (L) together with the first measurement report. For example, the intermediate relay UE (L) may map or indicate the measurement value for link 2 measured by the intermediate relay UE (L) to hop count 2, and map or indicate the first measurement report to hop count 3, and then report both the measurement value for link 2 and the first measurement report to the last relay UE (X). The intermediate relay UE may transmit to the last relay UE a second measurement report including the local ID (L_A) that may be associated with the local ID (A) included in the first measurement report of the remote UE (for example, a local ID configured by the last relay UE), or the second measurement report in which the local ID (A) is replaced with the local ID (LA). Upon receiving the second measurement report, the last relay UE may report to the gNB a third measurement report including the signal strength of link 1 (Uu link) measured by the last relay UE, the signal strength of link 3 measured by the remote UE, and the signal strength of link 2 measured by the intermediate relay UE (in this case, each hop count may be mapped to the corresponding signal strength). Alternatively, the last relay UE (X) may report or transmit to the gNB a third measurement report further including a local ID (Z_A) assigned by the gNB, which may be associated with the local ID (L_A) included in the report by the intermediate relay UE. Alternatively, the last relay UE (X) may transmit or report to the gNB the third measurement report in which the local ID (L_A) is replaced with the local ID (X_A). For example, the third measurement report reported by the last relay UE to the gNB may include the measurement value of link 3 mapped to the hop count (=3) of the remote UE (A), the measurement value of link 2 mapped to the hop count (=2) of the intermediate relay UE (L), the measurement value of link 1 mapped to the hop count (=1) of the last relay UE (X), and the local ID (X_A). In this case, the gNB may recognize, based on the local ID (X_A) included in the third measurement report, that the measurement values or signal strengths included in the third measurement report represent reports of signal strength for each link or hop along the path (e.g., indirect path) leading to the remote UE (A).

The proposed method described above may be applied to both event-triggered reporting and periodic reporting methods. In addition, the proposed method may be extendable and applicable even when the number of hops increases and a plurality of intermediate relay UEs exist. Furthermore, the proposed method may also be applied to multi-hop U2U, and in this case, the gNB or the last relay UE may be replaced with a source remote UE.

Accordingly, the proposed method may effectively ensure that the signal strength of each hop is reported to the gNB even when the gNB and the intermediate relay UE are not in the RRC_CONNECTED state.

FIG. 21 is a diagram for explaining a method by which a UE performs a multi-hop-based U2N relay operation.

As described above, the UE may operate as a last relay UE in multi-hop-based U2N relay communication. For example, the UE, which is a relay UE capable of being directly connected to a cell or BS, may deliver or transmit data or messages of a remote UE to the cell or BS through a Uu connection. The U2N relay may be performed using multiple hops based on a plurality of relay UEs. In this case, the UE may establish or configure an SL connection or a direct connection with a first intermediate relay UE for the U2N relay. The UE may receive a message of the remote UE or transmit or deliver a message of the BS for the remote UE through the SL connection or direct connection. Alternatively, the first intermediate relay UE may establish an SL connection or a direct connection with another intermediate relay UE, i.e., a second intermediate relay UE, and may transmit and receive messages for the remote UE through the second intermediate relay UE. Alternatively, the first intermediate relay UE may also establish an SL connection or a direct connection with the remote UE and may transmit and receive messages for the remote UE. Meanwhile, a PC5 SL connection link between UEs may be defined as an SL connection, a direct connection, and/or a hop. Hereinafter, for convenience of explanation, the PC5 SL connection link will be collectively referred to as a connection between two UEs.

Referring to FIG. 21, the UE may establish, set up, or configure a first connection with the BS and a second connection with a first relay UE for the U2N relay (S211). As described above, the UE may relay or transmit and receive data or messages between the remote UE and the BS through the first and second connections. The first connection may be a Uu link with the BS, and the second connection may be a PC5 link, which is an SL connection between UEs. The first relay UE may be in the RRC_IDLE state or RRC_INACTIVE state.

Next, the UE may receive a first message including a measurement reporting configuration associated with the UE through the first connection (S213). The measurement reporting configuration may include configuration information for a measurement resource of the second connection (e.g., SL-PRS), a measurement type (e.g., SL-RSRP or SD-RSRP), a measurement period, a measurement reporting event, and a threshold (for example, a threshold for triggering measurement reporting or a threshold related to relay UE reselection).

Next, the UE may transmit, through the second connection, a second message for configuring measurement reporting for the first relay UE, based on the measurement reporting configuration (S215). For example, when the first message (or the measurement reporting configuration) further includes a first local ID assigned by the UE or the BS in relation to the first connection (for example, a local ID assigned to identify the remote UE for transmission of the data or messages of the remote UE in relation to the first connection), the UE may recognize or identify that the measurement reporting configuration is for configuring measurement reporting not only for the UE but also for multiple hops related to the U2N relay. In this case, based on the measurement reporting configuration, the UE may transmit the second message for configuring measurement reporting for the first relay UE to the first relay UE through the second connection. For example, the second message may include information for configuring measurement reporting for the second connection or for a third connection between the first relay UE and another relay UE, i.e., a second relay UE (or the remote UE). Alternatively, the second message may further include a 1-bit indicator indicating which connection, among the second connection and the third connection, the measurement reporting is configured for. Here, the measurement reporting configuration included in the second message may include the same or similar configuration information as the measurement reporting configuration described above. For example, the measurement reporting configuration included in the second message may include configuration information for a measurement resource (e.g., SL-PRS), a measurement type (e.g., SL-RSRP or SD-RSRP), a measurement period, a threshold (for example, a threshold for triggering measurement reporting or a threshold related to relay UE reselection), and/or whether event-based measurement reporting is used, a measurement reporting event condition.

When the first local ID is not included in the first message, the UE may determine that the measurement reporting configuration is provided only for configuring the measurement reporting thereof and may not transmit the second message through the second connection.

Alternatively, the UE may additionally include, in the second message, a second local ID such that the first relay UE is capable of identifying that the configuration of measurement reporting for the connections (SL connections) for the U2N relay needs to be sequentially transmitted. Here, the second local ID may be a local ID for the remote UE assigned by the UE or the first relay UE to identify the remote UE on the second connection. In addition, the UE may previously store that the second local ID is associated or linked with the first local ID, and thus, the UE may recognize that the second local ID should be used for forwarding a message including the first local ID received through the first connection, or that the first local ID should be used for forwarding a message including the second local ID received through the second connection. Alternatively, after transmitting the second message, the UE may receive, through the second connection, a measurement report that includes measurement values for the direct connections or SL connections related to the U2N relay. For example, the U2N relay may be connected in the order of the BS, UE, first relay UE, second relay UE, and remote UE. In this case, the UE may receive a measurement report including a first measurement value for a third connection between the first relay UE and the second relay UE, and a second measurement value for a fourth connection between the second relay UE and the remote UE. Here, the first measurement value may be an SL-RSRP or SD-RSRP measurement value measured for the third connection according to the measurement reporting configured through the second message, and the second measurement value may be an SL-RSRP or SD-RSRP measurement value measured for the fourth connection according to the measurement reporting configured by the first relay UE for the second relay UE based on the second message. In this case, to identify that the first measurement value and the second measurement value correspond to different connections, the measurement report may further include information on a hop count corresponding to each of the first and second measurement values.

Alternatively, the first relay UE may be in an RRC idle state or an RRC inactive state. Even in this case, if the local ID assigned for identifying the remote UE is used for each connection, the BS may receive, through the last relay UE, measurement values for signal strength or quality for each of the hops of the U2N relay, even without directly configuring measurement reporting for each hop.

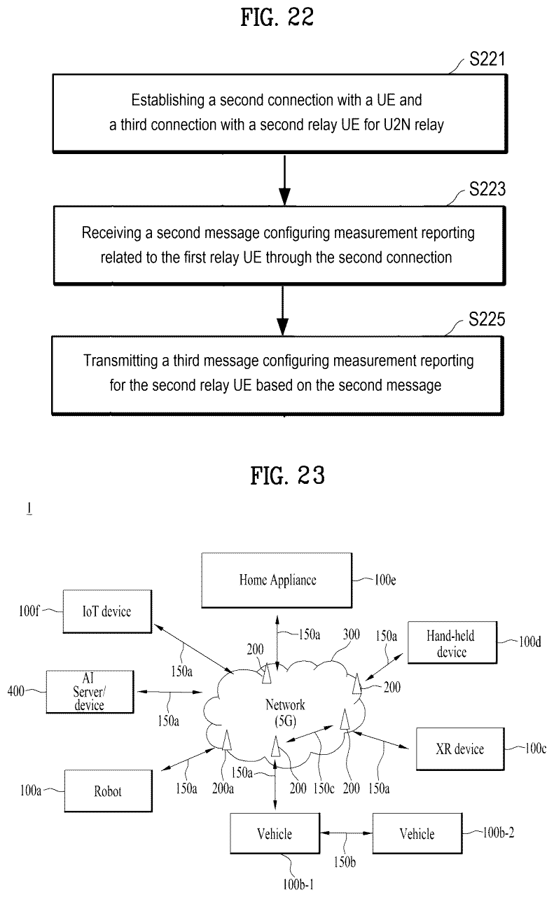

FIG. 22 is a diagram for explaining a method by which a first relay UE receives a measurement reporting configuration.

The first relay UE may be an intermediate relay UE that forms a second connection with a last relay UE capable of being directly connected to a cell or a BS for U2N relay and forms a third connection with a second relay UE (or a remote UE). The first relay UE may be in an RRC idle state or an RRC inactive state, in which measurement reporting is incapable of being directly configured by the cell or BS.

Referring to FIG. 22, the first relay UE may establish, set up, or configure a second connection with the UE and a third connection with the second relay UE for U2N relay (S221).

Next, the first relay UE may receive, through the second connection, a second message for configuring measurement reporting associated with the first relay UE (S223). As described above, the second message may include configuration information for a measurement resource for the third connection (e.g., SL-PRS), a measurement type (e.g., SL-RSRP or SD-RSRP), a measurement period, a measurement reporting event, and a threshold (for example, a threshold for triggering measurement reporting and/or a threshold related to relay UE reselection).

Next, the first relay UE may transmit a third message for configuring measurement reporting for the second relay UE (or the remote UE) based on the second message (S225). For example, when a second local ID assigned to identify the remote UE in relation to the second connection is further included in the second message, the first relay UE may transmit the third message for configuring measurement reporting for the second relay UE (or the remote UE) based on the second message. In this case, the third message may include a third local ID assigned for identifying the remote UE in relation to the third connection. On the other hand, when the second local ID is not included in the second message, the first relay UE may determine that the measurement reporting configuration according to the second message is provided only for the first relay UE and may not transmit the third message through the third connection.

Alternatively, the first relay UE may transmit a measurement report that includes measurement values for direct connections or SL connections related to the U2N relay. For example, the U2N relay may be connected in the order of the BS, UE, first relay UE, second relay UE, and remote UE. In this case, when the first relay UE receives a measurement report including a second measurement value for a fourth connection between the second relay UE and the remote UE, the first relay UE may add a first measurement value for the third connection between the first relay UE and the second relay UE to the measurement report and provide or transmit the measurement report to the UE through the second connection. Here, the first measurement value may be an SL-RSRP or SD-RSRP measurement value measured for the third connection according to the measurement reporting configured through the second message, and the second measurement value may be an SL-RSRP or SD-RSRP measurement value measured for the fourth connection according to the measurement reporting configured by the first relay UE for the second relay UE based on the second message. In this case, to identify that the first measurement value and the second measurement value correspond to different connections, the first relay UE may further include, in the measurement report, information on hop counts corresponding to each of the first and second measurement values.

As described above, the proposed disclosure may ensure that measurement reports for all hops or SL connections are reported to the gNB even when an intermediate relay UE in an RRC_IDLE or RRC_INACTIVE state exists, by configuring a local ID for a remote UE for each hop or SL connection in multi-hop U2N relay. In addition, the proposed disclosure may minimize delays in the configuration of the multi-hop U2N relay by enabling rapid configuration of measurement reporting, subsequent QoS splitting, and RLC channel configuration, without requiring an RRC connection transition of the intermediate relay UE in the RRC_IDLE or RRC_INACTIVE state during the configuration of measurement reporting for SL connections.

Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

FIG. 23 illustrates a communication system applied to the present disclosure.

Referring to FIG. 23, a communication system 1 applied to the present disclosure includes wireless devices, BSs (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

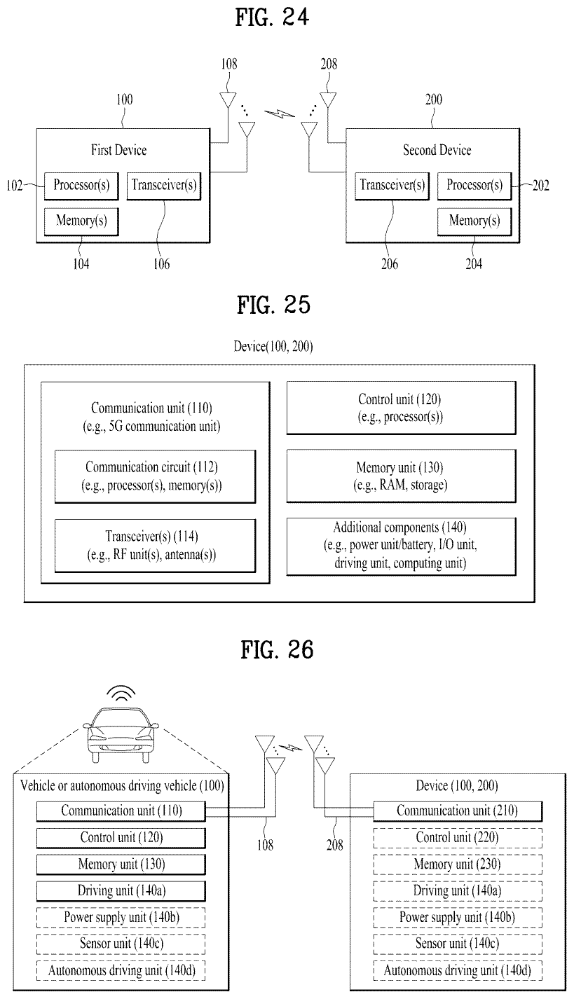

FIG. 24 illustrates a wireless device applicable to the present disclosure.

Referring to FIG. 24, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 23.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, the first wireless device 100 or a UE may include the processor(s) 102 connected to the transceiver(s) 106 and the memory(s) 104. The memory(s) 104 may include at least one program capable of performing operations related to the embodiments described with reference to FIGS. 16 to 22. For example, the operations may include: establishing a first connection with a BS for U2N relay; establishing a second connection with a first relay UE for the U2N relay; receiving, through the first connection, a first message including a measurement reporting configuration; and based on that a first local ID assigned for identifying a remote UE in relation to the first connection is further included in the first message, transmitting, through the second connection, a second message for configuring measurement reporting for the first relay UE based on the measurement reporting configuration.

The processor(s) 102 may be configured to control the transceiver(s) 106 to: establish a first connection with a BS for U2N relay; establish a second connection with a first relay UE for the U2N relay; receive, through the first connection, a first message including a measurement reporting configuration; and based on that a first local ID assigned for identifying a remote UE in relation to the first connection is further included in the first message, transmit, through the second connection, a second message for configuring measurement reporting for the first relay UE based on the measurement reporting configuration.

Alternatively, there is provided a processing device including the processor(s) 102 and the memory(s) 104. The processing device may include: at least one processor; and at least one memory connected to the at least one processor and configured to store instructions that, when executed by the at least one processor, cause the UE to: establish a first connection with a BS for U2N relay; establish a second connection with a first relay UE for the U2N relay; receive, through the first connection, a first message including a measurement reporting configuration; and based on that a first local ID assigned for identifying a remote UE in relation to the first connection is further included in the first message, transmit, through the second connection, a second message for configuring measurement reporting for the first relay UE based on the measurement reporting configuration.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Specifically, the second wireless device 200 or a first relay UE may include the processor(s) 202 connected to the transceiver(s) 206 and the memory(s) 204. The memory(s) 204 may include at least one program capable of performing operations related to the embodiments described with reference to FIGS. 16 to 22.

The processor(s) 202 may be configured to control the transceiver(s) 206 to: establish a second connection with a UE for U2N relay; establish a third connection with a second relay UE for the U2N relay; receive, through the second connection, a second message for configuring measurement reporting associated with the first relay UE; and based on inclusion of a second local ID assigned for identifying a remote UE in relation to the second connection, transmit, through the third connection, a third message for configuring measurement reporting for the second relay UE based on the second message.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of wireless devices to which the present disclosure is applied

FIG. 25 illustrates another example of a wireless device applied to the present disclosure. The wireless device may be implemented in various forms according to a use-case/service (refer to FIG. 23).

Referring to FIG. 25, wireless devices 100 and 200 may correspond to the wireless devices 100 and 200 of FIG. 24 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 24. For example, the transceiver(s) 114 may include the one or more transceivers 106 and 206 and/or the one or more antennas 108 and 208 of FIG. 24. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 23), the vehicles (100b-1 and 100b-2 of FIG. 23), the XR device (100c of FIG. 23), the hand-held device (100d of FIG. 23), the home appliance (100e of FIG. 23), the IoT device (100f of FIG. 23), a digital broadcast terminal, a hologram device, a public safety device, an MTC device, a medicine device, a fintech device (or a finance device), a security device, a climate/environment device, the AI server/device (400 of FIG. 23), the BSs (200 of FIG. 23), a network node, etc. The wireless device may be used in a mobile or fixed place according to a use-example/service.

In FIG. 25, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Examples of Vehicles or Autonomous Vehicles to which the Present Disclosure is Applied

FIG. 26 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 26, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 25, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are combinations of the components and features of the present disclosure in a predetermined form. Unless explicitly stated otherwise, each component or feature should be considered optional. Each component or feature may be implemented in a form not combined with other components or features. It is also possible to combine some components and/or features to constitute an embodiment of the present disclosure. The order of operations described in the embodiments of the present disclosure may be changed. Some configurations or features of one embodiment may be included in another embodiment, or may be replaced with corresponding configurations or features of another embodiment. It is apparent that claims not explicitly in a cited relationship in the claims may be combined to constitute an embodiment, or may be included as new claims through amendments after filing.

In this document, the embodiments of the present disclosure have been mainly described focusing on the signal transmission and reception relationship between the UE and the BS. The transmission and reception relationship may be identically or similarly extended to the signal transmission and reception between the UE and the relay, or between the BS and the relay. Specific operations described herein as being performed by the BS may, in some cases, be performed by the upper node. That is, in a network composed of a plurality of network nodes including the BS, various operations performed for communication with the UE may be performed by the BS or by other network nodes different from the BS. The term “base station” may be replaced with terms such as fixed station, Node B, eNode B (eNB), or access point. Similarly, the term “terminal” may be replaced with terms such as user equipment (UE), mobile station (MS), or mobile subscriber station (MSS).

The embodiments of the present disclosure may be implemented by various means, for example, hardware, firmware, software, or a combination thereof. In the case of implementation by hardware, the embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, or microprocessors.

In the case of implementation by firmware or software, the embodiments of the present disclosure may be implemented in the form of modules, procedures, functions, or the like for performing the functions or operations described above. The software code may be stored in a memory unit and driven by a processor. The memory unit may be located inside or outside the processor, and may exchange data with the processor by various means already known.

It will be apparent to those skilled in the art that the present disclosure may be embodied in other specific forms without departing from the features of the present disclosure. Therefore, the above detailed description should not be construed as restrictive in all aspects but should be considered illustrative. The scope of the present disclosure should be determined by a reasonable interpretation of the appended claims, and all modifications within the equivalent scope of the present disclosure are included in the scope of the present disclosure.

What is claimed is:

1. A method performed by a user equipment (UE), the method comprising:
establishing a first connection with a base station (BS) for UE-to-network (U2N) relay;
establishing a second connection with a first relay UE for the U2N relay;
receiving, through the first connection, a first message comprising a measurement reporting configuration associated with the UE; and
based on a first local identifier (ID), assigned for identifying a remote UE in relation to the first connection, being further included in the first message, transmitting, through the second connection, a second message for configuring measurement reporting for the first relay UE based on the measurement reporting configuration.

2. The method of claim 1, wherein the second message further comprises a second local ID assigned for identifying the remote UE in relation to the second connection, and
wherein the second local ID is associated with the first local ID.

3. The method of claim 1, wherein the second message comprises configuration information for configuring measurement reporting for a third connection between the first relay UE and a second relay UE for the U2N relay.

4. The method of claim 1, wherein the second message comprises configuration information for configuring measurement reporting for one of the second connection or a third connection between the first relay UE and a second relay UE for the U2N relay.

5. The method of claim 4, wherein the second message further comprises a 1-bit indicator indicating the one connection.

6. The method of claim 1, further comprising receiving a measurement report comprising measurement values measured based on the second message,
wherein the measurement report comprises a first measurement value for a third connection between the first relay UE and a second relay UE, a second measurement value for a fourth connection between the second relay UE and the remote UE, and a second local ID assigned for identifying the remote UE in relation to the second connection.

7. The method of claim 6, wherein the measurement report further comprises information on hop counts corresponding to each of the first measurement value and the second measurement value.

8. The method of claim 1, wherein the first relay UE is in a radio resource control (RRC) idle state or an RRC inactive state.

9. The method of claim 1, wherein the UE is a last relay UE directly connected to the BS.

10. At least one non-transitory computer-readable storage medium comprising instructions that, when executed by at least one processor, cause the at least one processor to perform operations, the operations comprising:
establishing a first connection with a base station (BS) for user equipment-to-network (U2N) relay;
establishing a second connection with a first relay user equipment (UE) for the U2N relay;
receiving, through the first connection, a first message comprising a measurement reporting configuration; and
based on a first local identifier (ID), assigned for identifying a remote UE in relation to the first connection, being further included in the first message, transmitting, through the second connection, a second message for configuring measurement reporting for the first relay UE based on the measurement reporting configuration.

11. A user equipment (UE) comprising:
a radio frequency (RF) transceiver; and
a processor connected to the RF transceiver,
wherein the processor is configured to control the RF transceiver to:
establish a first connection with a base station (BS) for UE-to-network (U2N) relay;
establish a second connection with a first relay UE for the U2N relay;
receive, through the first connection, a first message comprising a measurement reporting configuration; and
based on a first local identifier (ID), assigned for identifying a remote UE in relation to the first connection, being further included in the first message, transmit, through the second connection, a second message for configuring measurement reporting for the first relay UE based on the measurement reporting configuration.

12. The UE of claim 11, wherein the second message further comprises a second local ID assigned for identifying the remote UE in relation to the second connection, and
wherein the second local ID is associated with the first local ID.

13. A processing device configured to control a user equipment (UE), the processing device comprising:
at least one processor; and
at least one memory connected to the at least one processor and configured to store instructions that, when executed by the at least one processor, cause the UE to:
establish a first connection with a base station (BS) for UE-to-network (U2N) relay;
establish a second connection with a first relay UE for the U2N relay;
receive, through the first connection, a first message comprising a measurement reporting configuration; and
based on a first local identifier (ID), assigned for identifying a remote UE in relation to the first connection, being further included in the first message, transmit, through the second connection, a second message for configuring measurement reporting for the first relay UE based on the measurement reporting configuration.

14. A method performed by a first relay user equipment (UE), the method comprising:
establishing a second connection with a UE for UE-to-network (U2N) relay;
establishing a third connection with a second relay UE for the U2N relay;
receiving, through the second connection, a second message for configuring measurement reporting associated with the first relay UE; and
based on inclusion of a second local identifier (ID) assigned for identifying a remote UE in relation to the second connection, transmitting, through the third connection, a third message for configuring measurement reporting for the second relay UE based on the second message.

15. A first relay user equipment (UE) comprising:
a radio frequency (RF) transceiver; and
a processor connected to the RF transceiver,
wherein the processor is configured to control the RF transceiver to:
establish a second connection with a UE for UE-to-network (U2N) relay;
establish a third connection with a second relay UE for the U2N relay;
receive, through the second connection, a second message for configuring measurement reporting associated with the first relay UE; and
based on inclusion of a second local identifier (ID) assigned for identifying a remote UE in relation to the second connection, transmit, through the third connection, a third message for configuring measurement reporting for the second relay UE based on the second message.
